(19) United States
(12) Patent Application Publication
(10) Pub. No.: US 2025/0374054 A1
(43) Pub. Date: Dec. 4, 2025

(54) SUBSCRIPTION-BASED TECHNIQUES FOR COMMUNICATING THIRD-PARTY INFORMATION

(71) Applicant: QUALCOMM INCORPORATED, San Diego, CA (US)

(72) Inventors: Kefeng Zhang, Beijing (CN); Haris Zisimopoulos, London (GB); Carlos Marcelo Dias Pazos, Carlsbad, CA (US)

(21) Appl. No.: 18/876,586

(22) PCT Filed: Aug. 9, 2022
(86) PCT No.: PCT/CN2022/111066

§ 371 Date: Dec. 18, 2024

(51) Int. Cl. H04W 12/084; H04W 8/20; H04W 12/033

(52) U.S. Cl. CPC H04W 12/084; H04W 8/205; H04W 12/033

(57) ABSTRACT

Methods, systems, and devices for wireless communications are described. A first network entity of a first service provider may obtain, from a first user equipment (UE), an invite message for initiating a call between with a second UE that includes an identity associated with the first UE and an authorization server. Based on whether the first UE is subscribed to a third-party information service, the first network entity may obtain third-party information from the authorization server. The first network entity may output the invite message to a second network entity of a second service provider, where the invite message output by the first network entity includes the third-party information in accordance with whether the third-party information is obtained. Based on whether the second UE is subscribed to a third-party information verification service, the second network entity may verify the third-party information and output the invite message to the second UE.

### CROSS REFERENCE

The present Application is a 371 national stage filing of International PCT Application No. PCT/CN2022/111066 by Zhang et al. entitled “SUBSCRIPTION-BASED TECHNIQUES FOR COMMUNICATING THIRD-PARTY INFORMATION,” filed Aug. 9, 2022, which is assigned to the assignee hereof, and which is expressly incorporated by reference in its entirety herein.

### INTRODUCTION

The following relates to wireless communications, including subscription-based third-party information communication. Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support subscription-based techniques for communicating third-party information. For example, the described techniques support the communication of third-party information between user equipments (UEs) as part of a call initiation based on respective subscriptions of the UEs. For instance, a first UE associated with a first service provider (e.g., an originating internet protocol (IP) multimedia subsystem (IMS) service provider) may transmit an invite message to a first network entity of the first service provider as part of an initiation of a call with a second UE associated with a second service provider (e.g., a terminating IMS service provider). The invite message transmitted by the first UE may include an identity associated with the first UE and a third-party authorization server that is configured to provide the third-party information based on whether the first UE is authorized to communicate the third-party information. In response to receiving the invite message, the first network entity may use subscription information associated with the first UE to determine whether the first UE is authorized to use the identity as part on the call initiation (e.g., whether the first UE has subscribed to a service to communicate the third-party information). If the first UE is subscribed, the first network entity may retrieve the third-party information from the third-party authorization server (e.g., included in a name card associated with the first UE). The first network entity may transmit the invite message to a second network entity of the second service provider so that the invite message may be communicated to the second UE, where the invite message transmitted by the first network entity includes the third-party information.

The second network entity may receive the invite message and use subscription information associated with the second UE to determine whether the second UE has subscribed to a service to verify the third-party information included in the invite message. If the second UE is subscribed, the second network entity may verify the third-party information and transmit the invite message including the third-party information to the second UE, which may render (e.g., and display) the third-party information as part of the call initiation.

A method for wireless communication at a first network entity of a first service provider is described. The method may include obtaining, from a first UE associated with the first service provider, an invite message associated with initiation of a call between the first UE and a second UE associated with a second service provider, where the invite message, as obtained from the UE, includes an identity associated with the first UE and a third-party authorization server, determining, based on subscription information associated with the first UE, that the first UE is authorized to use the identity, obtaining, from the third-party authorization server based on the determination that the first UE is authorized to use the identity, third-party information associated with the first UE, and outputting the invite message to a second network entity of the second service provider, where the invite message, as output to the second network entity, includes the third-party information.

A first network entity of a first service provider for wireless communication is described. The first network entity may include a memory, and at least one processor coupled with the memory. The at least one processor may be configured to obtain, from a first UE associated with the first service provider, an invite message associated with initiation of a call between the first UE and a second UE associated with a second service provider, where the invite message, as obtained from the UE, includes an identity associated with the first UE and a third-party authorization server, determine, based on subscription information associated with the first UE, that the first UE is authorized to use the identity, obtain, from the third-party authorization server based on the determination that the first UE is authorized to use the identity, third-party information associated with the first UE, and output the invite message to a second network entity of the second service provider, where the invite message, as output to the second network entity, includes the third-party information.

Another first network entity of a first service provider for wireless communication is described. The first network entity may include means for obtaining, from a first UE associated with the first service provider, an invite message associated with initiation of a call between the first UE and a second UE associated with a second service provider, where the invite message, as obtained from the UE, includes an identity associated with the first UE and a third-party authorization server, means for determining, based on subscription information associated with the first UE, that the first UE is authorized to use the identity, means for obtaining, from the third-party authorization server based on the determination that the first UE is authorized to use the identity, third-party information associated with the first UE, and means for outputting the invite message to a second network entity of the second service provider, where the invite message, as output to the second network entity, includes the third-party information.

A non-transitory computer-readable medium having code for wireless communication stored thereon is described. The code, when executed by a first network entity of a first service provider, may cause the first network entity to obtain, from a first UE associated with the first service provider, an invite message associated with initiation of a call between the first UE and a second UE associated with a second service provider, where the invite message, as obtained from the UE, includes an identity associated with the first UE and a third-party authorization server, determine, based on subscription information associated with the first UE, that the first UE is authorized to use the identity, obtain, from the third-party authorization server based on the determination that the first UE is authorized to use the identity, third-party information associated with the first UE, and output the invite message to a second network entity of the second service provider, where the invite message, as output to the second network entity, includes the third-party information.

In some examples of the method, network entities, and non-transitory computer-readable medium described herein, determining that the first UE may be authorized to use the identity may include operations, features, means, or instructions for obtaining the subscription information from a subscriber server of the first service provider, where the subscription information includes an indication that the first UE may be authorized to use the identity.

Some examples of the method, network entities, and non-transitory computer-readable medium described herein may further include operations, features, means, or instructions for determining an address of the third-party authorization server based on the identity and outputting, to the third-party authorization server based on the determination of the address, a request to verify whether the first UE may be authorized to communicate the third-party information associated with the first UE via the invite message as output to the second network entity. In some examples of the method, network entities, and non-transitory computer-readable medium described herein, obtaining the third-party information may include operations, features, means, or instructions for obtaining the third-party information based on an authorization of the first UE to communicate the third-party information.

In some examples of the method, network entities, and non-transitory computer-readable medium described herein outputting the request may include operations, features, means, or instructions for outputting the request to the third-party authorization server via an exposure function of the first service provider for communicating with network entities outside of the first service provider. In some examples of the method, network entities, and non-transitory computer-readable medium described herein obtaining the third-party information may include operations, features, means, or instructions for obtaining the third-party information from the third-party authorization server via the exposure function.

Some examples of the method, network entities, and non-transitory computer-readable medium described herein may further include operations, features, means, or instructions for outputting, to a signing server, the third-party information for encryption based on the subscription information including an indication that the first UE may be subscribed to a service to encrypt the third-party information and obtaining, from the signing server, the encrypted third-party information, where the invite message, as output to the second network entity, includes the encrypted third-party information.

Some examples of the method, network entities, and non-transitory computer-readable medium described herein may further include operations, features, means, or instructions for encrypting the third-party information based on the subscription information including an indication that the first UE may be subscribed to a service to encrypt the third-party information, where the invite message, as output to the second network entity, includes the encrypted third-party information.

Some examples of the method, network entities, and non-transitory computer-readable medium described herein may further include operations, features, means, or instructions for outputting, to the first UE during registration of the first UE with the first service provider, a message including information indicative of the identity based on the subscription information, where the invite message, as obtained from the first UE, includes the identity based on the output of the message.

Some examples of the method, network entities, and non-transitory computer-readable medium described herein may further include operations, features, means, or instructions for obtaining, from the third-party authorization server, a request to allocate the identity to the first UE, where outputting the message including the information indicative of the identity may include operations, features, means, or instructions for outputting the message including the information indicative of the identity based on the request.

In some examples of the method, network entities, and non-transitory computer-readable medium described herein, obtaining the third-party information may include operations, features, means, or instructions for obtaining a name card that includes the third-party information, where the invite message, as output the second network entity, includes the name card.

In some examples of the method, network entities, and non-transitory computer-readable medium described herein, the identity may be a public user identity.

In some examples of the method, network entities, and non-transitory computer-readable medium described herein, the public user identity may be allocated by the third-party authorization server.

In some examples of the method, network entities, and non-transitory computer-readable medium described herein, the identity may be a third-party specific user identity and the invite message, as obtained from the first UE, includes a token associated with an authorization of the first UE to communicate the third-party information via the invite message as output to the second network entity.

In some examples of the method, network entities, and non-transitory computer-readable medium described herein, the third-party information may be based on a display name included in the invite message as obtained from the first UE.

In some examples of the method, network entities, and non-transitory computer-readable medium described herein, the display name may be included in a source header of the invite message as obtained from the first UE.

In some examples of the method, network entities, and non-transitory computer-readable medium described herein, the third-party information may be based on one or more parameters included in a call-information header of the invite message as obtained from the first UE.

Some examples of the method, network entities, and non-transitory computer-readable medium described herein may further include operations, features, means, or instructions for obtaining, from a third UE associated with the first service provider, a second invite message associated with initiation of a second call between the third UE and a fourth UE associated with the second service provider, where the second invite message, as obtained from the third UE, includes a second identity associated with the third UE and the third-party authorization server, determining, based on subscription information associated with the third UE, that the third UE may be unauthorized to use the second identity, and outputting the second invite message to the second network entity, where the second invite message, as output to the second network entity, excludes third-party information associated with the third UE based on the third UE being unauthorized to use the second identity.

A method for wireless communication at a first network entity of a first service provider is described. The method may include obtaining, from a second network entity of a second service provider, an invite message associated with initiation of a call between a first UE associated with the first service provider and a second UE associated with the second service provider, where the invite message, as obtained from the second network entity, includes third-party information associated with the second UE, verifying the third-party information based on subscription information associated with the first UE that indicates that the first UE is subscribed to a service to verify the third-party information, and outputting, to the first UE, the invite message, where the invite message, as output to the first UE, includes the third-party information based on the verification.

A first network entity of a first service provider for wireless communication is described. The first network entity may include a memory, and at least one processor coupled with the memory. The at least one processor may be configured to obtain, from a second network entity of a second service provider, an invite message associated with initiation of a call between a first UE associated with the first service provider and a second UE associated with the second service provider, where the invite message, as obtained from the second network entity, includes third-party information associated with the second UE, verify the third-party information based on subscription information associated with the first UE that indicates that the first UE is subscribed to a service to verify the third-party information, and output, to the first UE, the invite message, where the invite message, as output to the first UE, includes the third-party information based on the verification.

Another first network entity of a first service provider for wireless communication is described. The first network entity may include means for obtaining, from a second network entity of a second service provider, an invite message associated with initiation of a call between a first UE associated with the first service provider and a second UE associated with the second service provider, where the invite message, as obtained from the second network entity, includes third-party information associated with the second UE, means for verifying the third-party information based on subscription information associated with the first UE that indicates that the first UE is subscribed to a service to verify the third-party information, and means for outputting, to the first UE, the invite message, where the invite message, as output to the first UE, includes the third-party information based on the verification.

A non-transitory computer-readable medium having code for wireless communication stored thereon is described. The code, when executed by a first network entity of a first service provider, may cause the first network entity to obtain, from a second network entity of a second service provider, an invite message associated with initiation of a call between a first UE associated with the first service provider and a second UE associated with the second service provider, where the invite message, as obtained from the second network entity, includes third-party information associated with the second UE, verify the third-party information based on subscription information associated with the first UE that indicates that the first UE is subscribed to a service to verify the third-party information, and output, to the first UE, the invite message, where the invite message, as output to the first UE, includes the third-party information based on the verification.

In some examples of the method, network entities, and non-transitory computer-readable medium described herein, verifying the third-party information may include operations, features, means, or instructions for outputting, to a verification server of the first service provider, a request to verify the third-party information and obtaining, from the verification server based on the request, an indication that the third-party information may be verified.

Some examples of the method, network entities, and non-transitory computer-readable medium described herein may further include operations, features, means, or instructions for obtaining the subscription information from a subscriber server of the first service provider, where the subscription information includes an indication that the first UE may be subscribed to the service.

Some examples of the method, network entities, and non-transitory computer-readable medium described herein may further include operations, features, means, or instructions for obtaining, from the second network entity, a second invite message associated with initiation of a second call between a third UE associated with the first service provider and a fourth UE associated with the second service provider, where the second invite message, as obtained from the second network entity, includes third-party information associated with the fourth UE, determining that the third UE may be unsubscribed from a service to verify the third-party information associated with the fourth UE based on second subscription information associated with the third UE, and outputting, to the third UE, the second invite message, where the second invite message, as output to the third UE, excludes the third-party information associated with the fourth UE based on the determination that the third UE may be unsubscribed from the service to verify the third-party information associated with the fourth UE.

### BRIEF DESCRIPTION OF THE DRAWINGS

FIG. 1 illustrates an example of a wireless communications system that supports subscription-based techniques for communicating third-party information in accordance with one or more aspects of the present disclosure.

FIG. 2 illustrates an example of a network architecture that supports subscription-based techniques for communicating third-party information in accordance with one or more aspects of the present disclosure.

FIG. 3 illustrates an example of a wireless communications system that supports subscription-based techniques for communicating third-party information in accordance with one or more aspects of the present disclosure.

FIG. 4 illustrates an example of a message diagram that supports subscription-based techniques for communicating third-party information in accordance with one or more aspects of the present disclosure.

FIG. 5 illustrates an example of a process flow that supports subscription-based techniques for communicating third-party information in accordance with one or more aspects of the present disclosure.

FIGS. 6 and 7 show block diagrams of devices that support subscription-based techniques for communicating third-party information in accordance with one or more aspects of the present disclosure.

FIG. 8 shows a block diagram of a communications manager that supports subscription-based techniques for communicating third-party information in accordance with one or more aspects of the present disclosure.

FIG. 9 shows a diagram of a system including a device that supports subscription-based techniques for communicating third-party information in accordance with one or more aspects of the present disclosure.

FIGS. 10 through 15 show flowcharts illustrating methods that support subscription-based techniques for communicating third-party information in accordance with one or more aspects of the present disclosure.

### DETAILED DESCRIPTION

Some wireless communications systems may support the addition of third-party information to a call invite message so that additional information may be presented to a receiving device, for example, beyond a caller identifier (ID). For example, to initiate a call between UEs, a first UE of a first (e.g., originating) service provider (e.g., that supports a first internet protocol (IP) multimedia subsystem (IMS) network) may transmit a session initiation protocol (SIP) invite message to a first network entity of the first service provider (e.g., a call session control function (CSCF)), the invite message including a third-party specific user ID and a token associated with the first UE. The first network entity may forward the SIP invite message to a third-party authorization server that authorizes, based on the third-party specific user ID and the token, whether the first UE is allowed to transmit third-party information, which may include other types of caller information (e.g., beyond a caller ID) such as a user of the first UE, a photo of the user, a user ID, a position of the user within a company, or the company associated with the user, among other types of third-party information. If the first UE is authorized, the authorization server may transmit the third-party specific information back to the first network entity, and the first network entity may send the invite message, now including the third-party information, to a second UE of a second (e.g., terminating) service provider.

In some cases, it may be desirable for a service provider to provide third-party information communication services as a subscription-based service, for example, to enable charging its customers for such services to provide an additional source of revenue. Additionally or alternatively, allocation of the token to the first UE for authorization by the authorization server may be relatively complex. For example, the first UE may obtain the token via the internet or via an application at the first UE before initiating the call. Thus, alternatives to support verifying whether the first UE is authorized to transmit third-party information may be desired.

The techniques, devices, and methods described herein support subscription-based third-party information communication. For example, subscription information for various third-party information services may be configured and stored in a subscription server (e.g., a home subscriber server (HSS)) in originating or terminating service providers such that third-party information services may be provided based on subscriptions of respective UEs. For instance, a first UE associated with a first service provider may transmit an invite message to a first network entity of the first service provider as part of a call initiation with a second UE associated with a second service provider. The invite message transmitted by the first UE may include an identity associated with the first UE and a third-party authorization server, which may be used by the third-party authorization server to verify whether the first UE is authorized to communicate third-party information as part of the call initiation. In some aspects, the identity may be a public user identity that is allocated to the first UE by the first service provider based on a subscription of the first UE to one or more third-party information services.

The first network entity may use the subscription of the first UE (e.g., retrieved from the subscription server) to verify whether the first UE is authorized use the identity as part of the call initiation. If the first UE is authorized, the first network entity may request the third-party authorization server to verify whether the first UE is authorized to communicate the third-party information based on the identity and provide the third-party information if the first UE is authorized. The first network entity may transmit the invite message to a second network entity of the second service provider, where the invite message transmitted by the first network entity includes the third-party information. The second network entity may use a subscription of the second UE to determine whether the second UE is subscribed to a service to verify the third-party information. If the second UE is subscribed, the second network entity may verify the third-party information and transmit the invite message including the third-party information to the second UE. If the second UE is unsubscribed, the second network entity may remove the third-party information from the invite message and transmit the invite message to the second UE.

Aspects of the present disclosure may be implemented to realize one or more advantages. For example, by supporting subscription-based third-party information services, additional caller information may be communicated as part of a call initiation based on UE subscriptions, thereby improving user-experience while providing additional revenue opportunities to service providers, among other benefits. Additionally, allocation of the identity via a service provider (e.g., an internet protocol (IP) multimedia subsystem (IMS) network supported by the service provider) may reduce a complexity associated with supporting the authorization of a UE to communicate third-party information as part of a call initiation. For example, the identity may be allocated as part of a registration of the UE with a network entity of the service provider (e.g., with the IMS network), thereby avoiding token allocation via, for example, the internet.

Aspects of the disclosure are initially described in the context of wireless communications systems and a network architecture. Aspects of the disclosure are additional described in the context of a message diagram and a process flow. Aspects of the disclosure are further illustrated by and described with reference to apparatus diagrams, system diagrams, and flowcharts that relate to subscription-based techniques for communicating third-party information.

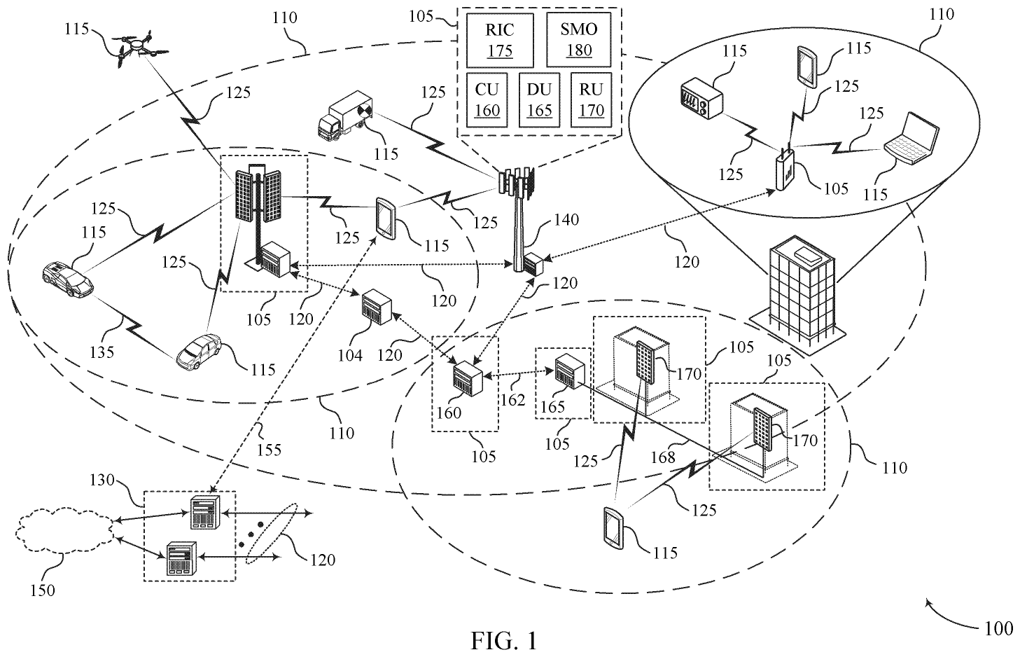

FIG. 1 illustrates an example of a wireless communications system 100 that supports subscription-based techniques for communicating third-party information in accordance with one or more aspects of the present disclosure. The wireless communications system 100 may include one or more network entities 105, one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some aspects, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node (which may be referred to as a node, a network node, a network entity 105, or a wireless node) may include, be, or be included in (e.g., be a component of) a base station (e.g., any base station described herein), a UE 115 (e.g., any UE described herein), a network controller, an apparatus, a device, a computing system, an integrated access and backhauling (IAB) node, a distributed unit (DU) 165, a central unit (CU) 160, a remote/radio unit (RU) 170 (which may also be referred to as a remote radio unit (RRU)), and/or another processing entity configured to perform any of the techniques described herein. For example, a network node may be a UE 115. As another example, a network node may be a base station or network entity 105. As another example, a first network node may be configured to communicate with a second network node or a third network node. In one aspect of this example, the first network node may be a UE 115, the second network node may be a base station, and the third network node may be a UE 115. In another aspect of this example, the first network node may be a UE 115, the second network node may be a base station, and the third network node may be a base station. In yet other aspects of this example, the first, second, and third network nodes may be different relative to these examples. Similarly, reference to a UE 115, base station, apparatus, device, computing system, or the like may include disclosure of the UE 115, base station, apparatus, device, computing system, or the like being a network node. For example, disclosure that a UE 115 is configured to receive information from a base station also discloses that a first network node is configured to receive information from a second network node. Consistent with this disclosure, once a specific example is broadened in accordance with this disclosure (e.g., a UE 115 is configured to receive information from a base station also discloses that a first network node is configured to receive information from a second network node), the broader example of the narrower example may be interpreted in the reverse, but in a broad open-ended way. In the example above where a UE 115 is configured to receive information from a base station also discloses that a first network node is configured to receive information from a second network node, the first network node may refer to a first UE 115, a first base station, a first apparatus, a first device, a first computing system, a first set of one or more one or more components, a first processing entity, or the like configured to receive the information; and the second network node may refer to a second UE 115, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some aspects, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some aspects, network entities 105 may communicate with one another via a backhaul communication link 120 (e.g., in accordance with an X2, Xn, or other interface protocol) either directly (e.g., directly between network entities 105) or indirectly (e.g., via a core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an IAB network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a CU 160, a DU 165, an RU 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some aspects, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support subscription-based techniques for communicating third-party information as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some aspects, a network entity 105 (e.g., a base station 140, an RU 170) may be movable and therefore provide communication coverage for a moving coverage area 110. In some aspects, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs 115 via a device-to-device (D2D) communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1: M) system in which each UE 115 transmits to each of the other UEs 115 in the group. In some aspects, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may support calls (e.g., voice calls, video calls) between UEs 115. The wireless communications system 100 may additionally support the communication of third-party information as part of an invite message used to initiate a call between UEs 115. For example, a first network entity 105 (e.g., a CSCF) of an originating service provider may add (e.g., append, insert, include) third-party information received from a third-party authorization server to an invite message (e.g., a SIP invite) associated with initiating a call between a first UE 115 associated with the originating service provider and a second UE 115 associated with a terminating service provider. Accordingly, when the invite message is received at the second UE 115, the third-party information may be rendered and displayed at the second UE 115, for example, in addition to a caller ID of the first UE 115 (e.g., an originating or calling party telephone number used to identify a caller). In some aspects, third-party information may include third-party caller information (e.g., a third-party specific user ID), such as a user of the first UE 115, a photo of the user, a user ID, a position of the user within a company (e.g., sales manager), the company associated with the user, or an indication that the third-party information has been certified (e.g., verified), among other types of caller information other than the caller ID.

In accordance with examples described herein, the wireless communications system 100 may support subscription-based third-party information services as part of a call initiation. For example, the first network entity 105 may determine whether the first UE 115 is subscribed to a service to communicate the third-party information and may include or exclude the third-party information from the invite message based on the determination. Additionally or alternatively, a second network entity 105 (e.g., a CSCF) of the terminating service provider may determine whether the second UE 115 is subscribed to a service to verify the third-party information included in the invite message. Based on whether the second UE 115 is subscribed, the second network entity 105 may verify the third-party information (e.g., via a verification server) and transmit the invite message including the third-party information to the second UE 115 (e.g., if verified) or may remove the third-party information from the invite message and transmit the invite message excluding the third-party information to the second UE 115.

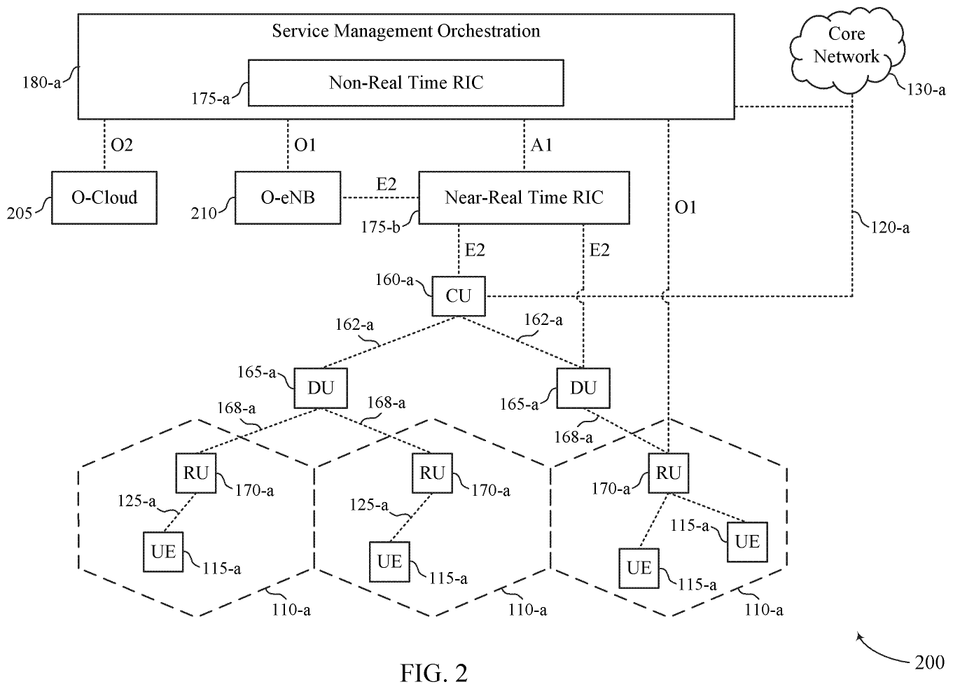

FIG. 2 illustrates an example of a network architecture 200 (e.g., a disaggregated base station architecture, a disaggregated RAN architecture) that supports subscription-based techniques for communicating third-party information in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some aspects, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some aspects, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some aspects, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) based on a functional split, such as those defined by the 3rd Generation Partnership Project (3GPP). In some aspects, a DU 165-a may further host one or more low PHY layers. Each layer may be implemented with an interface configured to communicate signals with other layers hosted by the DU 165-a, or with control functions hosted by a CU 160-a.

In some aspects, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some aspects, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an Al interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some aspects, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some aspects, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

In accordance with examples described herein, the network architecture 200 may support subscription-based third-party information services as part of a call initiation, for example, between a first UE 115 associated with an originating service provider and a second UE 115 associated with a terminating service provider. For example, a first network entity 105 of the originating service provider may determine whether the first UE 115 is subscribed to a service to communicate third-party information as part of the call initiation and may include or exclude the third-party information from an invite message associated with the call initiation based on the determination. Additionally or alternatively, a second network entity 105 of the terminating service provider may determine whether the second UE 115 is subscribed to a service to verify the third-party information included in the invite message. Based on whether the second UE 115 is subscribed, the second network entity 105 may verify the third-party information and transmit the invite message including the third-party information to the second UE 115 (e.g., if verified) or may remove the third-party information from the invite message and transmit the invite message excluding the third-party information to the second UE 115.

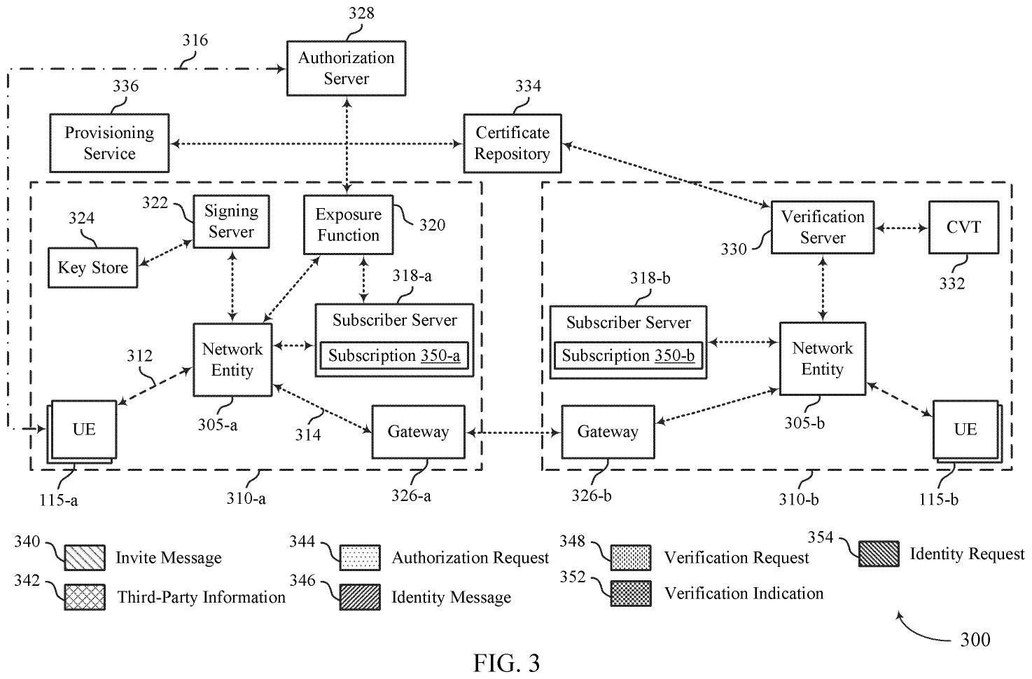

FIG. 3 illustrates an example of a wireless communications system 300 that supports subscription-based techniques for communicating third-party information in accordance with one or more aspects of the present disclosure. The wireless communications system 300 may implement or be implemented by aspects of wireless communications system 100 and network architecture 200 described with reference to FIGS. 1 and 2, respectively. For example, the wireless communications system 300 may include a network entity 305-a, a network entity 305-b, UEs 115-a, and UEs 115-b, which may be examples of the corresponding devices described herein, including with reference to FIGS. 1 and 2.

The wireless communications system 300 may include a network 310-a (e.g., an IMS network) that is supported (e.g., hosted) by a first service provider and a network 310-b (e.g., an IMS network) that is supported by a second service provider. In some aspects, the wireless communications system 300 may implement (e.g., be an example of) a framework for supporting calls (e.g., voice calls, video calls, calls via voice over IP (VoIP)) between UEs 115 of the first and second service providers. For example, the wireless communications system 300 may implement a signature-based handling of asserted information using tokens (SHAKEN) framework that provides an end-to-end architecture for the authentication and assertion of caller information (e.g., caller ID, third-party information 342) by an originating service provider (e.g., the first service provider) and the verification of the caller information by a terminating service provider.

The network 310-a may include one or more UEs 115-a, and the network 310-b may include one or more UEs 115-b, where the UEs 115 may be referred to as or be examples of a SIP user agent (UA) that may initiate and perform calls with other SIP UAs. The network 310-a may also include the network entity 305-a, and the network 310-b may include the network entity 305-b. The network entities 305 may support call routing functionality. For example, the network entity 305-a and the network entity 305-b may be examples of CSCFs (e.g., SIP servers, CSCF servers) that support the management and routing of invite messages 340 communicated between UEs 115 such that calls may be initiated.

The network 310-a may include a gateway 326-a, and the network 310-b may include a gateway 326-b. The gateways 326 may support communication of messages between service providers (e.g., between the networks 310). For example, the gateways 326 may be functions at respective edges of the networks 310 that operate as a network-to-network interface (NNI) or peering interconnection point between service providers. In some aspects, the gateways 326 may be entry and exit points for calls between service providers. In some aspects, the gateways 326 may be examples of an interconnection border control function (IBCF)/transition gateway (TrGW).

The network 310-a may also include a signing server 322 that supports encryption (e.g., and decryption) functionality (e.g., cryptographic services) for calls. For example, the signing server 322 may be secure and include or communicate with a key store 324 (e.g., via an encrypted interface, such as a transport layer security encrypted interface) that includes encryption keys (e.g., secret keys, secret private keys). The signing server 322 may use the encryption keys to encrypt (e.g., sign) messages for secure delivery. In some aspects, the signing server 322 may use an encryption key to create a personal assertion token (PASSporT) In some aspects, the signing server 322 may be an example of a secure telephone identity (STI) authentication service (STI-AS), and the key store 324 may be an example of a secure key store (SKS), where an SKS may be a logical highly secure element for access by the STI-AS. In some aspects, the signing server 322 may encrypt message in accordance with STI revisited (STIR) mechanisms. In some aspects, the network 310-b may also include a signing server 322 or a key store 324 to support encryption and decryption functionality for calls.

The network 310-a may include a subscriber server 318-a, and the network 310-b may include a subscriber server 318-b. The subscriber servers 318 may be configured to store subscriber information 350 associated with the respective UEs 115. The subscriber information 350 may include various IMS subscription information of the UEs 115 (e.g., the UEs 115-a and 115-b), including, for example, subscriptions to various third-party information services. In some examples, the subscriber servers 318 may be examples of an HSS.

The network 310-a may include an exposure function 320 that supports communications with entities (e.g., network entities 105) outside of (e.g., not included in) the network 310-a. For example, messages between a component of the network 310-a (e.g., the network entity 305-a) and an entity outside of the network 310-a (e.g., an authorization server 328) may be communicated (e.g., routed) via the exposure function 320. In some aspects, some messages communicated within the network 310-a may be routed via the exposure function 320. For example, in some aspects, subscription information 350-a communicated between the network entity 305-a and the subscriber server 318 may be routed via the exposure function 320. In some aspects, the exposure function 320 may be an example of a network exposure function (NEF).

The network 310-b may include a verification server 330 that supports verification functionality of caller information. For example, the verification server 330 may be configured to verify (e.g., certify) whether caller information included in an invite message 340 is authentic (e.g., trusted). In some aspects, the verification server 330 may communicate with a certificate repository 334 of the wireless communications system 300 (e.g., referenced in an identity header field of an invite message 340) to retrieve a provider public key certificate and verify the caller information based on the certificate. In some aspects, the verification server 330 may include or communicate with a call validation treatment (CVT) 332, which may be a logical function (e.g., an application server function or a third-party application) for applying call analytics and treatments based on a signature being positively or negatively verified by the verification server 330. In some aspects, the verification server 330 may be an example of an STI-verification service (STI-VS). In some aspects, the verification server 330 may communicate with the certificate repository 334 via a hypertext transfer protocol secure (HTTPS) interface.

In some aspects, the certificate repository 334 may be an example of an STI-certificate repository (STI-CR). In some aspects, the certificate repository 334 may be a publicly accessible store for public key certificates (e.g., associated with various service providers). In some aspects, the wireless communications system 300 may include a provisioning service 336 (e.g., a certificate provisioning service), which may be a logical service used to provision certificates for STI services.

The wireless communications system 300 may include an authorization server 328, which may be an example of a third-party authorization server. For example, the authorization server 328 may support the authorization of third-party information communication and provisioning of third-party information 342 as part of a call initiation.

The wireless communications system 300 may support communications between the components and devices. For example, the UEs 115 may communicate with respective network entities 305 via respective communication links 312, which may be examples of communication links 125 described with reference to FIGS. 1 and 2. Additionally, other components of the wireless communications system 300 may communicate via respective communication links 314, which may be examples of communication links 125, backhaul communication links 120, midhaul communication links 162, or fronthaul communication links 168, among other links described with reference to FIGS. 1 and 2. In some aspects, the authorization server 328 may communicate with a UE 115-a via a communication link 316, which may include communications via an application layer (e.g., via the internet, via an application installed at the UE 115-a).

In accordance with examples disclosed herein, the wireless communications system 300 may support subscription-based third-party information services for a call between a UE 115-a and a UE 115-b. For instance, in the example of FIG. 3, the first service provider associated with the network 310-a may be an originating service provider, and the second service provider associated with the network 310-b may be a terminating service provider. That is, an invitation for a call may originate at the network 310-a (e.g., initially be received from a UE 115-a) and terminate at the network 310-b (e.g., be forwarded to a UE 115-b to be accepted or declined). For example, a UE 115-a may transmit an invite message 340 to the network entity 305-a as part of an initiation of a call between the UE 115-a and a UE 115-b. The invite message 340, as transmitted by the UE 115-a, may include an identity of associated with the UE 115-a and the authorization server 328. In some aspects, the identity may be a public user identity (e.g., an IMS public user identity (IMPU)) allocated by a third-party. In some aspects, the identity may be a third-party specific user identity of the UE 115-a. Here, the invite message 340 may also include a token used in authorization of whether the UE 115-a may communicate third-party information 342.

The network entity 305-a may receive the invite message 340 and determine whether the UE 115-a is authorized to use the identity (e.g., include the identity in the invite message 340) based on subscription information 350-a associated with the UE 115-a. For example, the network entity 305-a may check the subscription information 350-a (e.g., retrieved from the subscriber server 318-a) to determine whether the UE 115-a is subscribed to a service to communicate the third-party information 342 as part of initiating the call (e.g., via the invite message 340). If the UE 115-a is subscribed, the network entity 305-a may determine (e.g., resolve) an address of the authorization server 328 such that an authorization request 344 may be transmitted to the authorization server 328. For example, the network entity 305-a may use the identity to determine the address or may use realm information of the authorization server 328 that is included in invite message 340 to determine the address. Based on (e.g., after) determining the address, the network entity 305-a may transmit (e.g., via the exposure function 320) the authorization request 344 to the authorization server 328 that requests for the authorization server 328 to verify whether the UE 115-a is authorized to communicate third-party information 342 associated with the UE 115-a (e.g., to the UE 115-b) via the invite message 340.

In some aspects, the authorization request 344 may include the identity associated with the UE 115-a and the authorization server 328, the third-party specific user identity, or the token. In some aspects, the authorization request 344 may be included in the invite message 340, for example, as received from the UE 115-a or as transmitted by the network entity 305-a (e.g., the). Here, the network entity 305-a may transmit (e.g., forward) the invite message 340 to the transmit the authorization server 328 in order to transmit the authorization request 344. In some aspects, transmitting the invite message 340 to the authorization server 328 may be an implicit request to verify whether the UE 115-a is authorized to communicate the third-party information 342 based on the invite message 340 including the identity, the third-party specific user identity, or the token.

The authorization server 328 may receive the authorization request 344 (e.g., via the exposure function 320) and may determine (e.g., verify) whether the UE 115-a is authorized to communicate the third-party information 342 in response to the authorization request 344. For example, the authorization server 328 may use the identity or the token to verify that the UE 115-a is authorized to communicate the third-party information 342. Based on determining that the UE 115-a is authorized, the authorization server 328 transmit (e.g., provision, send, output) the third-party information 342 to the network entity 305-a (e.g., via the exposure function 320) for inclusion in the invite message 340. In some examples, the authorization server 328 may transmit the third-party information via a name card (e.g., an enterprise name card). For example, the authorization server 328 may create a name card for the UE 115-a (e.g., to be delivered in a SIP header of the invite message 340) that includes the third-party information 342.

In some aspects, if the authorization server 328 determines that the UE 115-a is unauthorized to communicate the third-party information 342, the authorization server 328 may reject the authorization request 344 and transmit an indication of the rejection to the network entity 305-a. Here, the initiation of the call may proceed with the communication of the third-party information 342.

The network entity 305-a may receive the third-party information 342 and continue with the initiation of the call. In some aspects, the network entity 305-a may transmit the invite message 340 that now includes the third-party information 342 to the network entity 305-b (e.g., via the gateways 326) in response to receiving the third-party information 342 from the authorization server 328. For example, the network entity 305-a may add the received third-party information 342 to the invite message 340 such that the invite message 340, as transmitted by the network entity 305-a, may include the third-party information 342. Alternatively, the authorization server 328 may add the third-party information 342 to the invite message 340, for example, if the invite message 340 is transmitted to the authorization server 328 as part of requesting the authorization server 328 to verify that the UE 115-a is authorized to communicate the third-party information 342. Here, the invite message 340 may be communicated such that the invite message 340, as received from the authorization server 328 and transmitted by the network entity 305-a, may include the third-party information 342.

In some aspects, the network entity 305-a may determine whether the UE 115-a is subscribed to service to encrypt (e.g., sign) the third-party information (e.g., encrypt the name card, encrypt the invite message 340). For example, in response to receiving the third-party information 342 (e.g., included in or separate from the invite message 340), the network entity 305-a may check the subscription information 350-a (e.g., retrieved from the subscriber server 318-a) to determine whether the UE 115-a is subscribed to the encryption service. In some aspects, if the UE 115-a is subscribed to the encryption service, the network entity 305-a may transmit the third-party information 342 (e.g., the invite message 340 that includes the third-party information 342 as transmitted by the network entity 305-a) to the signing server 322. The signing server 322 may encrypt the third-party information 342 (e.g., the name card, the invite message 340), for example, using an encryption key and may transmit the encrypted third-party information 342 (e.g., the encrypted name card, the encrypted invite message 340) to the network entity 305-a. The network entity 305-a may receive the encrypted third-party information 342 and transmit the invite message 340 to the network entity 305-a, where the invite message 340, as transmitted by the network entity 305-a or received from the signing server 322, includes the encrypted third-party information 342 (e.g., is encrypted).

In some other aspects, if the UE 115-a is subscribed to the encryption service and the network entity 305-a supports performing encryption services, the network entity 305-a may encrypt the third-party information 342 (e.g., the name card, the invite message 340) and transmit the invite message 340 to the network entity 305-b, where the invite message 340, as transmitted by the network entity 305-a, includes the encrypted third-party information 342 (e.g., is encrypted).

In some aspects, if the UE 115-a is unsubscribed from the encryption service, the network entity 305-a may transmit the invite message 340 including the third-party information 342 to the network entity 305-b without encrypting the third-party information 342 (e.g., the name card, the invite message 340).

The network entity 305-b may receive the invite message 340 that includes the third-party information 342 associated with the UE 115-a. The network entity 305-b may determine that the invite message 340 includes the third-party information 342 and determine whether the UE 115-b is subscribed to a service to verify third-party information 342. For example, the network entity 305-b may check subscription information 350-b associated with the UE 115-b (e.g., retrieved from the subscriber server 318-b) to determine whether the UE 115-b is subscribed to the verification service. If the UE 115-b is subscribed to the verification service, the network entity 305-b may trigger a verification procedure to verify the third-party information 342. For example, the network entity 305-b may transmit a verification request 348 to the verification server 330 that requests for the verification server 330 to verify (e.g., authenticate) the third-party information 342. In some aspects, the network entity 305-b may transmit the invite message 340 to the verification server 330 in conjunction with the verification request 348 such that the verification server 330 may verify the third-party information 342 included in the invite message 340. In some aspects, the verification request 348 may be included in the invite message 340. In some aspects, transmitting the invite message 340 to the verification server 330 may be an implicit request to verify the third-party information 342 included in the invite message 340.

The verification server 330 may determine whether the third-party information 342 is verified and transmit a verification indication 352 to the network entity 305-b of the determination. For example, if the verification server 330 verifies the third-party information 342, the verification server 330 may transmit a verification indication 352 indicating that the third-party information 342 is verified. Alternatively, if the verification server 330 is unable to verify the third-party information 342, the verification server 330 may transmit a verification indication 352 indicating that the third-party information 342 is unverified.

Alternatively, if the network entity 305-b supports performing verification services, the network entity 305-b may trigger the verification procedure based on the UE 115-b being subscribed to the verification service and determine whether the third-party information 342 is verified at the network entity 305-b.

The network entity 305-b may transmit the invite message 340 to the UE 115-b as part of the initiation of the call based on the verification of the third-party information 342. For example, if the third-party information 342 is verified, the network entity 305-b may transmit the invite message 340 including the third-party information 342 to the UE 115-b to be rendered and displayed at the UE 115-b. Alternatively, if the third-party information 342 is unverified, the network entity 305-b may remove the third-party information 342 from the invite message 340 such that the invite message 340, as transmitted by the network entity 305-b to the UE 115-b, excludes the third-party information 342.

If a UE 115-a is unsubscribed from one or more third-party information services, the network entity 305-a may refrain from performing third-party information communication or encryption services as part of the initiation of the call. For example, the network entity 305-a may receive a second invite message 340 from a second UE 115-a. If the second UE 115-a is unsubscribed from the service to communicate third-party information 342, the network entity 305-a may refrain from communicating with the authorization server 328 and instead forward the second invite message 340 to the network entity 305-b without including third-party information 342 in the second invite message 340 (e.g., and after performing encryption services to encrypt the second invite message 340). If the second UE 115-a is unsubscribed from the service to encrypt the third-party information 342, the network entity 305-a retrieve the third-party information 342 from the authorization server 328 but may forward the second invite message 340 including the third-party information 342 to the network entity 305-b without encrypting the third-party information 342.

If a UE 115-b is unsubscribed from the service to verify the third-party information, the network entity 305-b may refrain from performing third-party information verification services as part of the initiation of the call. For example, the network entity 305-b may receive a second invite message 340 for initiating a call between a second UE 115-b and a second UE 115-a, and the second invite message 340 may include third-party information 342 associated with the second UE 115-a. However, the UE 115-b may be unsubscribed from the service to verify the third-party information 342. Here, the network entity 305-b may refrain from verifying the third-party information 342 and may instead remove the third-party information 342 from the second invite message 340 and transmit the second invite message 340 that now excludes the third-party information 342 to the second UE 115-b.

In some aspects, a UE 115-a may be configured with an identity associated with the UE 115-a and the authorization server 328 via an identity message 346. For example, during registration of the UE 115-a with the first service provider (e.g., with the network 310-a, with the network entity 305-a), the network entity 305-a may determine that the UE 115-a is subscribed to third-party information communication services based on associated subscription information 350-a. To support the communication of the third-party information 342 as part of a call initiation, the network entity 305-a may transmit an identity message 346 to the UE 115-a that includes the identity, which the UE 115-a may subsequently include in an invite message 340.

In some aspects, the subscriber server 318-a may expose (e.g., transmit) the subscription information 350-a of the UE 115-a to the authorization server 328 (e.g., via the exposure function 320). In response, the authorization server 328 may determine that the UE 115-a is subscribed to the third-party information communication service based on the exposed subscription information 350-a and transmit an identity request 354 to the network entity 305-a (e.g., via the exposure function 320) that requests for the network entity 305-a to allocate the identity to the UE 115-a. In some aspects, the authorization server 328 may allocate the identity to the UE 115-a and may transmit, to the network entity 305-a, an identity request 354 that includes the allocated identity and requests for the network entity 305-a to transmit the identity to the UE 115-a. In response to receiving the identity request 354, the network entity 305-a may transmit the allocated identity to the UE 115-a.

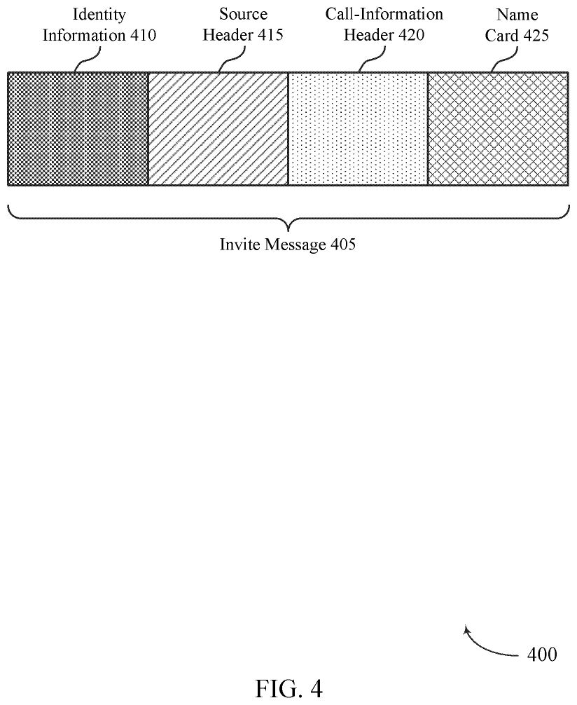

FIG. 4 illustrates an example of a message diagram 400 that supports subscription-based techniques for communicating third-party information in accordance with one or more aspects of the present disclosure. The message diagram 400 may be implemented by aspects of the wireless communications system 100, the network architecture 200, and the wireless communications system 300 described with reference to FIGS. 1, 2, and 3, respectively. For example, the message diagram 400 may include an invite message 405, which may be an example of an invite message 340 communicated between aspects of the wireless communications system 300.

The invite message 405 may include various information fields that support third-part information communication as part of call initiation between UEs 115. For example, the invite message 405 may include one or more of identity information 410, a source header 415, a call-information header 420, and a name card 425. In some aspects, information fields may be added or removed from the invite message 405 as the invite message 405 is routed from a first UE 115 associated with an originating service provider to a second UE 115 associated with a terminating service provider.

For example, the first UE 115 may transmit the invite message 405 to a first network entity 105 of the originating service provider. The invite message 405 as transmitted by the first UE 115 may include one or more of the identity information 410 and the source header 415. The identity information 410 may include an identity associated with the first UE 115 and a third-party authorization server (e.g., an authorization server 328). In some aspects, the identity may be a public user identity, such as a IMPU. In some aspects, the public user identity may be allocated to the first UE 115 by the third-party authorization server (e.g., during a registration of the first UE 115 with the originating service provider). In some aspects, the identity may be a third-party specific user identity, and the identity information 410 may also include a token associated with determining whether the first UE 115 is authorized to communicate third-party information (e.g., the name card 425) via the invite message 405.

In some aspects, the source header 415 may include a display name associated with the first UE 115. In some aspects, the display name may be an identifier of the first UE 115, such as a caller ID or an IP address associated with the first UE 115.

The first network entity 105 may use subscription information associated with the first UE 115 to determine that the first UE 115 is authorized to use the identity information 410 (e.g., include the identity information 410 in the invite message 405). In some aspects, the first network entity 105 may add (e.g., insert, append) a call-information header 420 to the invite message 405. For example, the first network entity 105 may use the source header 415 to determine one or more call information parameters and may add the call-information header 420 to the invite message 405 that includes the one or more call information parameters. In some aspects, the call information parameters may include an ID of the call or a destination of the invite message 405 (e.g., an identifier of the second UE 115), among other call information parameters.

In some aspects, the first network entity 105 may transmit the invite message 405 to the third-party authorization server, and the third-party authorization server may determine third-party information to add to the invite message 405. In some aspects, the third-party authorization server may determine (e.g., derive) the third-party information based on information in the source header 415 and the call-information header 420. For example, the third-party authorization server may use the display name included in the source header 415 to identify the first UE 115 and determine rich call data (RCD) about the first UE 115 stored at or otherwise accessible via the third-party authorization server for inclusion in the invite message 405 as third-party information.

In some aspects, the third-party authorization server may create the name card 425 that includes the third-party information and add the name card 425 to the invite message 405. Here, the third-party authorization server may transmit the invite message 405 with the name card 425 added to the first network entity 105. In some other aspects, the third-party authorization server may create and transmit the name card 425 to the first network entity 105, and the first network entity 105 may add the name card 425 to the invite message 405. For example, if the first network entity 105 transmits, without transmitting the invite message 405, a request for the third-party authorization server to verify whether the first UE 115 is authorized to communicate the third-party information, the third-party authorization server may transmit the name card 425 to the first network entity 105 without adding the name card 425 to the invite message 405. Here, the request may include the information from the source header 415 or the call-information header 420 for the third-party authorization server to identify the first UE 115 and determine the RCD to create the name card 425. In some aspects, the name card 425 may be added to be included in the call-information header 420.

The first network entity may transmit the invite message 405 that includes the identity information 410, source header 415, call-information header 420, and the name card 425 to a second network entity 105 for routing to the second UE 115. The second network entity 105 may determine whether the name card 425 is verified (e.g., in accordance with a subscription of the second UE 115) and may keep the name card 425 in the invite message 405 for transmission to the second UE 115 if the name card 425 is verified or may remove the name card 425 from the invite message 405 for transmission to the second UE 115 if the name card 425 is unverified or the second UE 115 is unsubscribed from a verification service for the name card 425.

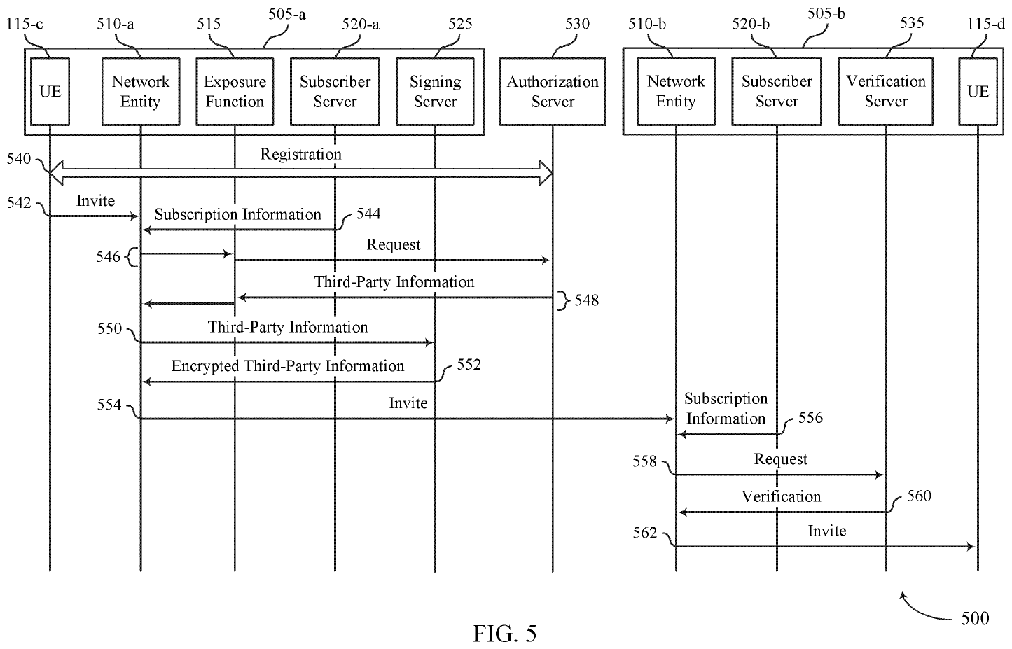

FIG. 5 illustrates an example of a process flow 500 that supports subscription-based techniques for communicating third-party information in accordance with one or more aspects of the present disclosure. The process flow 500 may be implemented by aspects of the wireless communications systems 100 or 300. For example, the process flow 500 may illustrate various communication between aspects of an network 505-a, an authorization server 530, and aspects of a network 505-b, which may be examples of corresponding devices described herein, including with reference to FIGS. 1 through 4. For example, the network 505-a may support an originating service provider and include a UE 115-c, a network entity 510-a, an exposure function 515, a subscriber server 520-a, and a signing server 525 (e.g., although other aspects may be included in the network 505-a). The network 505-b may support a terminating service provider and may include a UE 115-d, a network entity 510-b, a subscriber server 520-b, and a verification server 535. In some aspects, the network entities 510-a and 510-b may be examples of CSCFs or the network entities 305-a and 305-b, respectively, as described herein, including with reference to FIG. 3.

In the following description of the process flow 500, the operations may be performed in a different order than the order shown. Specific operations also may be left out of the process flow 500, or other operations may be added to the process flow 500. Further, although some operations or signaling may be shown to occur at different times for discussion purposes, these operations may actually occur at the same time.

At 540, the UE 115-c may register with the network 505-a (e.g., the originating service provider). For example, the UE 115-c may establish a connection with the network entity 510-a. In some aspects, as part of the registration, the UE 115-c may be allocated an identity associated with third-party information communication. For example, the identity may be associated with the UE 115-c and the authorization server 530 and may facilitate the authorization of whether the UE 115-c may communicate third-party information as part of a call initiation with the UE 115-d. In some aspects, the UE 115-c may be allocated the identity via the network entity 105-a. For example, the network entity 105-a may transmit an identity message to the UE 115-c that allocates the identity. In some aspects, the network entity 105-a may transmit the identity message to the UE 115-c in response to a request received from the authorization server 530, which may include the identity for the UE 115-c.

At 542, the UE 115-c may transmit an invite (e.g., an invite message 340, a SIP invite) to the network entity 510-a to initiate a call with the UE 115-d. In some aspects, the invite may include the identity allocated to the UE 115-c during registration of the UE 115-c.

At 544, the network entity 510-a may receive subscription information associated with the UE 115-c from the subscriber server 520-a. For example, the subscriber server 520-a may store the subscription information, and the network entity 510-a may retrieve the subscription information to determine whether the UE 115-c is authorized to use the identity (e.g., include the identity in the invite).

At 546, the network entity 510-a may transmit, to the authorization server 530, a request for the authorization server 530 to verify whether the UE 115-c is authorized to communicate third-party information associated with the UE 115-c via the invite. For example, the subscription information may include an indication that the UE 115-c is authorized to use the identity. Accordingly, the network entity 510-a may transmit the request to the authorization server 530. In some aspects, the network entity 510-a may transmit the request via the exposure function 515. For example, the network entity 510-a may resolve an address of the authorization server 530 based on the identity and the UE 115-c being authorized to use the identity and forward the request to the exposure function 515. The exposure function 515 may select the authorization server 530 based on the address and transmit the request to the authorization server 530. In some aspects, the request may be transmitted via the invite (e.g., the invite may be forwarded to the authorization server 530 and may include or function as the request).

At 548, in response to the request, the authorization server 530 may verify that the UE 115-c is authorized to communicate the third-party information via the invite. Based on the UE 115-c being authorized to communicate the third-party information, the authorization server 530 may determine the third-party information for the UE 115-c and transmit the third-party information to the network entity 510-a (e.g., via the exposure function 515). In some aspects, the authorization server 530 may create a name card that includes the third-party information and transmit the name card to the network entity 510-a. In some aspects, the authorization server 530 may add the name third-party information (e.g., name card) to the invite and transmit the invite to the network entity 510-a with the third-party information added to it. In some aspects, the network entity 510-a may add the third-party information to the invite in response to receiving the third-party information from the network entity 510-a.

At 550, the network entity 510-a may determine whether the UE 115-c is subscribed to a service to encrypt the third-party information (e.g., the invite). In the example of FIG. 5, the subscription information may include an indication that the UE 115-c is subscribed to the encryption service, and the network entity 510-a may transmit the third-party information (e.g., the invite) to the signing server 525 for encryption.

At 552, the network entity 510-a may receive the encrypted third-party information (e.g., the encrypted invite) from the signing server 525. In some aspects, the network entity 510-a may add the encrypted third-party information to the invite in response to receiving the encrypted third-party information from the signing server 525. In some aspects, the invite, as transmitted to the signing server 525, may include the third-party information. Here, the invite, as received from the signing server 525, may include the encrypted third-party information.

At 554, the network entity 510-a may transmit the invite to the network entity 510-b (e.g., via one or more gateways). The invite, as output by the network entity 510-a may include the encrypted third-party information.

At 556, the network entity 510-b may receive subscription information associated with the UE 115-d from the subscriber server 520-b. For example, the subscriber server 520-b may store the subscription information associated with the UE 115-d, and the network entity 510-b may retrieve the subscription information associated with the UE 115-d to determine whether the UE 115-d is subscribed to a service to verify the encrypted third-party information.

At 558, the network entity 510-b may transmit, to the verification server 535, a request to verify the encrypted third-party information. For example, the subscription information associated with the UE 115-d may include an indication that the UE 115-d is subscribed to the verification service. Accordingly, the network entity 510-b may transmit the request to the verification server 535. In some aspects, the request may be transmitted via the invite (e.g., the invite may be forwarded to the verification server 535 and may include or function as the request).

At 560, in response to the request, the verification server 535 may transmit verification of the encrypted third-party information. That is, the verification server 535 may verify the encrypted third-party information and transmit an indication to the network entity 510-b that the encrypted third-party information is verified.

At 562, the network entity 510-b may transmit the invite to the UE 115-d based on the verification of the encrypted third-party information. For example, the invite, as transmitted by the network entity 510-b, may include the encrypted third-party information based on being verified by the verification server 535. The UE 115-d may receive the invite and render the third-party information for display at the UE 115-d.

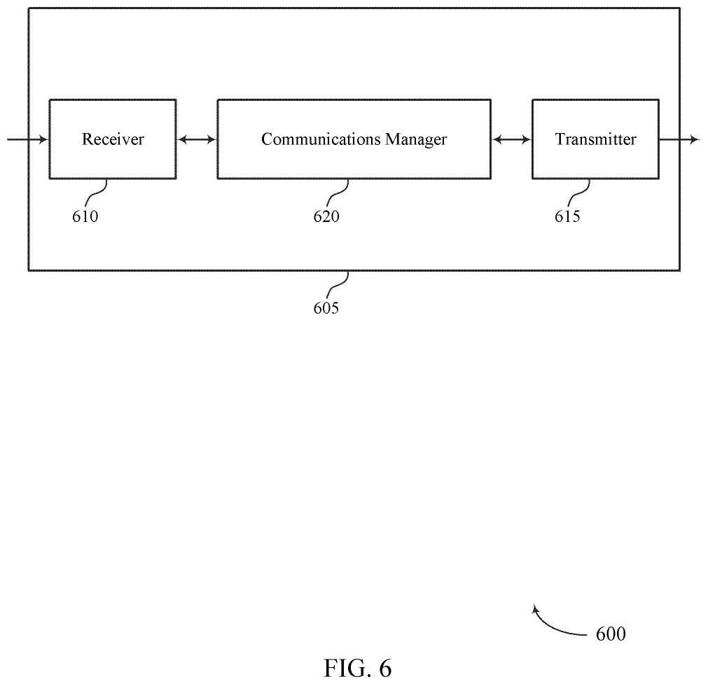

FIG. 6 shows a block diagram 600 of a device 605 that supports subscription-based techniques for communicating third-party information in accordance with one or more aspects of the present disclosure. The device 605 may be an example of aspects of a network entity 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some aspects, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some aspects, the transmitter 615 and the receiver 610 may be co-located in a transceiver, which may include or be coupled with a modem.

The communications manager 620, the receiver 610, the transmitter 615, or various combinations thereof or various components thereof may be examples of means for performing various aspects of subscription-based techniques for communicating third-party information as described herein. For example, the communications manager 620, the receiver 610, the transmitter 615, or various combinations or components thereof may support a method for performing one or more of the functions described herein.

In some aspects, the communications manager 620, the receiver 610, the transmitter 615, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first network entity of a first service provider in accordance with examples as disclosed herein. For example, the communications manager 620 may be configured as or otherwise support a means for obtaining, from a first UE associated with the first service provider, an invite message associated with initiation of a call between the first UE and a second UE associated with a second service provider, where the invite message, as obtained from the UE, includes an identity associated with the first UE and a third-party authorization server. The communications manager 620 may be configured as or otherwise support a means for determining, based on subscription information associated with the first UE, that the first UE is authorized to use the identity. The communications manager 620 may be configured as or otherwise support a means for obtaining, from the third-party authorization server based on the determination that the first UE is authorized to use the identity, third-party information associated with the first UE. The communications manager 620 may be configured as or otherwise support a means for outputting the invite message to a second network entity of the second service provider, where the invite message, as output to the second network entity, includes the third-party information.

Additionally, or alternatively, the communications manager 620 may support wireless communication at a first network entity of a first service provider in accordance with examples as disclosed herein. For example, the communications manager 620 may be configured as or otherwise support a means for obtaining, from a second network entity of a second service provider, an invite message associated with initiation of a call between a first UE associated with the first service provider and a second UE associated with the second service provider, where the invite message, as obtained from the second network entity, includes third-party information associated with the second UE. The communications manager 620 may be configured as or otherwise support a means for verifying the third-party information based on subscription information associated with the first UE that indicates that the first UE is subscribed to a service to verify the third-party information. The communications manager 620 may be configured as or otherwise support a means for outputting, to the first UE, the invite message, where the invite message, as output to the first UE, includes the third-party information based on the verification.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for subscription-based third-party information communication, for example, to support a service provider providing third-party information communication and encryption as a subscription-based service. As a result, security of communicating such information may be increased, among other benefits.

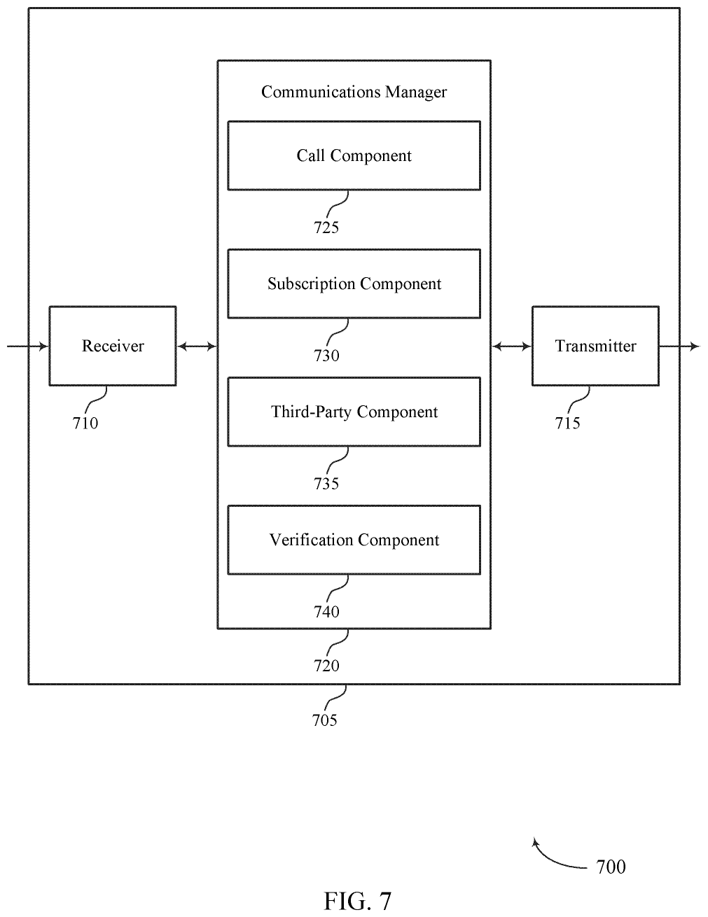

FIG. 7 shows a block diagram 700 of a device 705 that supports subscription-based techniques for communicating third-party information in accordance with one or more aspects of the present disclosure. The device 705 may be an example of aspects of a device 605 or a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some aspects, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some aspects, the transmitter 715 and the receiver 710 may be co-located in a transceiver, which may include or be coupled with a modem.

The device 705, or various components thereof, may be an example of means for performing various aspects of subscription-based techniques for communicating third-party information as described herein. For example, the communications manager 720 may include a call component 725, a subscription component 730, a third-party component 735, a verification component 740, or any combination thereof. The communications manager 720 may be an example of aspects of a communications manager 620 as described herein. In some aspects, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first network entity of a first service provider in accordance with examples as disclosed herein. The call component 725 may be configured as or otherwise support a means for obtaining, from a first UE associated with the first service provider, an invite message associated with initiation of a call between the first UE and a second UE associated with a second service provider, where the invite message, as obtained from the UE, includes an identity associated with the first UE and a third-party authorization server. The subscription component 730 may be configured as or otherwise support a means for determining, based on subscription information associated with the first UE, that the first UE is authorized to use the identity. The third-party component 735 may be configured as or otherwise support a means for obtaining, from the third-party authorization server based on the determination that the first UE is authorized to use the identity, third-party information associated with the first UE. The call component 725 may be configured as or otherwise support a means for outputting the invite message to a second network entity of the second service provider, where the invite message, as output to the second network entity, includes the third-party information.

Additionally, or alternatively, the communications manager 720 may support wireless communication at a first network entity of a first service provider in accordance with examples as disclosed herein. The call component 725 may be configured as or otherwise support a means for obtaining, from a second network entity of a second service provider, an invite message associated with initiation of a call between a first UE associated with the first service provider and a second UE associated with the second service provider, where the invite message, as obtained from the second network entity, includes third-party information associated with the second UE. The verification component 740 may be configured as or otherwise support a means for verifying the third-party information based on subscription information associated with the first UE that indicates that the first UE is subscribed to a service to verify the third-party information. The call component 725 may be configured as or otherwise support a means for outputting, to the first UE, the invite message, where the invite message, as output to the first UE, includes the third-party information based on the verification.

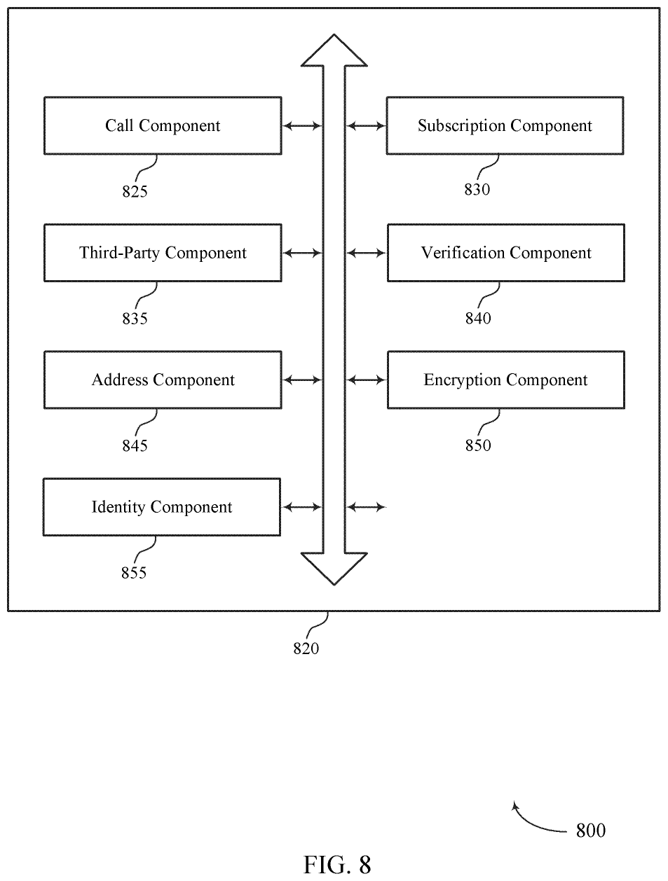

FIG. 8 shows a block diagram 800 of a communications manager 820 that supports subscription-based techniques for communicating third-party information in accordance with one or more aspects of the present disclosure. The communications manager 820 may be an example of aspects of a communications manager 620, a communications manager 720, or both, as described herein. The communications manager 820, or various components thereof, may be an example of means for performing various aspects of subscription-based techniques for communicating third-party information as described herein. For example, the communications manager 820 may include a call component 825, a subscription component 830, a third-party component 835, a verification component 840, an address component 845, an encryption component 850, an identity component 855, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communication at a first network entity of a first service provider in accordance with examples as disclosed herein. The call component 825 may be configured as or otherwise support a means for obtaining, from a first UE associated with the first service provider, an invite message associated with initiation of a call between the first UE and a second UE associated with a second service provider, where the invite message, as obtained from the UE, includes an identity associated with the first UE and a third-party authorization server. The subscription component 830 may be configured as or otherwise support a means for determining, based on subscription information associated with the first UE, that the first UE is authorized to use the identity. The third-party component 835 may be configured as or otherwise support a means for obtaining, from the third-party authorization server based on the determination that the first UE is authorized to use the identity, third-party information associated with the first UE. In some aspects, the call component 825 may be configured as or otherwise support a means for outputting the invite message to a second network entity of the second service provider, where the invite message, as output to the second network entity, includes the third-party information.

In some aspects, to support determining that the first UE is authorized to use the identity, the subscription component 830 may be configured as or otherwise support a means for obtaining the subscription information from a subscriber server of the first service provider, where the subscription information includes an indication that the first UE is authorized to use the identity.

In some aspects, the address component 845 may be configured as or otherwise support a means for determining an address of the third-party authorization server based on the identity. In some aspects, the third-party component 835 may be configured as or otherwise support a means for outputting, to the third-party authorization server based on the determination of the address, a request to verify whether the first UE is authorized to communicate the third-party information associated with the first UE via the invite message as output to the second network entity. In some aspects, to obtain the third-party information, the third-party component 835 may be configured as or otherwise support a means for obtaining the third-party information based on an authorization of the first UE to communicate the third-party information.

In some aspects, to support outputting the request, the third-party component 835 may be configured as or otherwise support a means for outputting the request to the third-party authorization server via an exposure function of the first service provider for communicating with network entities outside of the first service provider. In some aspects, to support obtaining the third-party information, the third-party component 835 may be configured as or otherwise support a means for obtaining the third-party information from the third-party authorization server via the exposure function.

In some aspects, the encryption component 850 may be configured as or otherwise support a means for outputting, to a signing server, the third-party information for encryption based on the subscription information including an indication that the first UE is subscribed to a service to encrypt the third-party information. In some aspects, the encryption component 850 may be configured as or otherwise support a means for obtaining, from the signing server, the encrypted third-party information, where the invite message, as output to the second network entity, includes the encrypted third-party information.

In some aspects, the encryption component 850 may be configured as or otherwise support a means for encrypting the third-party information based on the subscription information including an indication that the first UE is subscribed to a service to encrypt the third-party information, where the invite message, as output to the second network entity, includes the encrypted third-party information.

In some aspects, the identity component 855 may be configured as or otherwise support a means for outputting, to the first UE during registration of the first UE with the first service provider, a message including information indicative of the identity based on the subscription information, where the invite message, as obtained from the first UE, includes the identity based on the output of the message.

In some aspects, the identity component 855 may be configured as or otherwise support a means for obtaining, from the third-party authorization server, a request to allocate the identity to the first UE. In some aspects, to support outputting the message including the information indicative of the identity, the identity component 855 may be configured as or otherwise support a means for outputting the message including the information indicative of the identity based on the request.

In some aspects, to support obtaining the third-party information, the third-party component 835 may be configured as or otherwise support a means for obtaining a name card that includes the third-party information, where the invite message, as output the second network entity, includes the name card.

In some aspects, the identity is a public user identity.

In some aspects, the public user identity is allocated by the third-party authorization server.

In some aspects, the identity is a third-party specific user identity and the invite message, as obtained from the first UE, includes a token associated with an authorization of the first UE to communicate the third-party information via the invite message as output to the second network entity.

In some aspects, the third-party information is based on a display name included in the invite message as obtained from the first UE.

In some aspects, the display name is included in a source header of the invite message as obtained from the first UE.

In some aspects, the third-party information is based on one or more parameters included in a call-information header of the invite message as obtained from the first UE.

In some aspects, the call component 825 may be configured as or otherwise support a means for obtaining, from a third UE associated with the first service provider, a second invite message associated with initiation of a second call between the third UE and a fourth UE associated with the second service provider, where the second invite message, as obtained from the third UE, includes a second identity associated with the third UE and the third-party authorization server. In some aspects, the subscription component 830 may be configured as or otherwise support a means for determining, based on subscription information associated with the third UE, that the third UE is unauthorized to use the second identity. In some aspects, the call component 825 may be configured as or otherwise support a means for outputting the second invite message to the second network entity, where the second invite message, as output to the second network entity, excludes third-party information associated with the third UE based on the third UE being unauthorized to use the second identity.

Additionally, or alternatively, the communications manager 820 may support wireless communication at a first network entity of a first service provider in accordance with examples as disclosed herein. In some aspects, the call component 825 may be configured as or otherwise support a means for obtaining, from a second network entity of a second service provider, an invite message associated with initiation of a call between a first UE associated with the first service provider and a second UE associated with the second service provider, where the invite message, as obtained from the second network entity, includes third-party information associated with the second UE. The verification component 840 may be configured as or otherwise support a means for verifying the third-party information based on subscription information associated with the first UE that indicates that the first UE is subscribed to a service to verify the third-party information. In some aspects, the call component 825 may be configured as or otherwise support a means for outputting, to the first UE, the invite message, where the invite message, as output to the first UE, includes the third-party information based on the verification.

In some aspects, to support verifying the third-party information, the verification component 840 may be configured as or otherwise support a means for outputting, to a verification server of the first service provider, a request to verify the third-party information. In some aspects, to support verifying the third-party information, the verification component 840 may be configured as or otherwise support a means for obtaining, from the verification server based on the request, an indication that the third-party information is verified.

In some aspects, the subscription component 830 may be configured as or otherwise support a means for obtaining the subscription information from a subscriber server of the first service provider, where the subscription information includes an indication that the first UE is subscribed to the service.

In some aspects, the call component 825 may be configured as or otherwise support a means for obtaining, from the second network entity, a second invite message associated with initiation of a second call between a third UE associated with the first service provider and a fourth UE associated with the second service provider, where the second invite message, as obtained from the second network entity, includes third-party information associated with the fourth UE. In some aspects, the subscription component 830 may be configured as or otherwise support a means for determining that the third UE is unsubscribed from a service to verify the third-party information associated with the fourth UE based on second subscription information associated with the third UE. In some aspects, the call component 825 may be configured as or otherwise support a means for outputting, to the third UE, the second invite message, where the second invite message, as output to the third UE, excludes the third-party information associated with the fourth UE based on the determination that the third UE is unsubscribed from the service to verify the third-party information associated with the fourth UE.

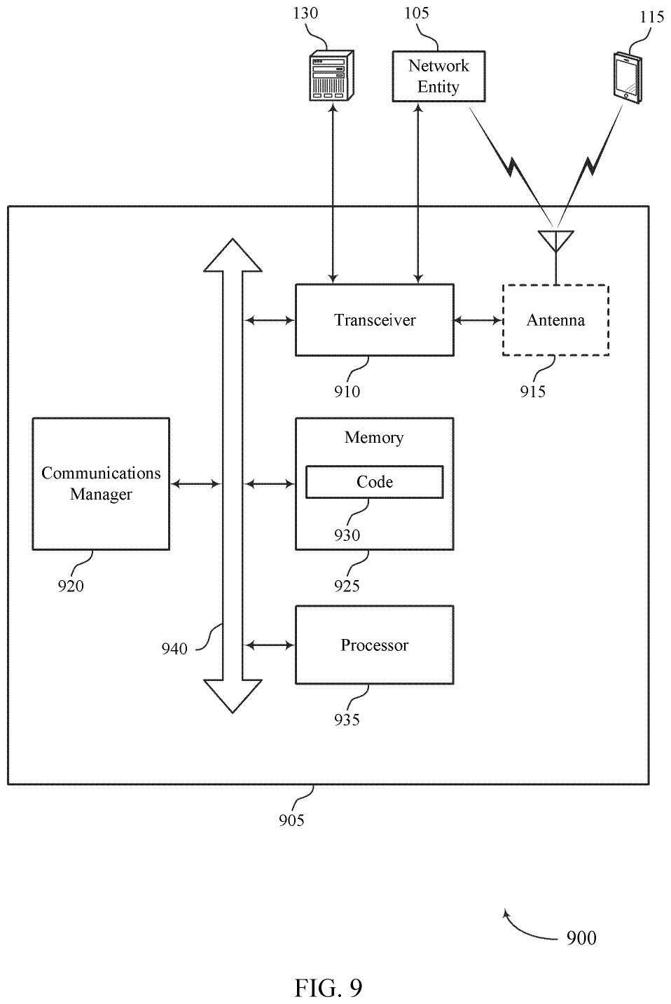

FIG. 9 shows a diagram of a system 900 including a device 905 that supports subscription-based techniques for communicating third-party information in accordance with one or more aspects of the present disclosure. The device 905 may be an example of or include the components of a device 605, a device 705, or a network entity 105 as described herein. The device 905 may communicate with one or more network entities 105, one or more UEs 115, or any combination thereof, which may include communications over one or more wired interfaces, over one or more wireless interfaces, or any combination thereof. The device 905 may include components that support outputting and obtaining communications, such as a communications manager 920, a transceiver 910, an antenna 915, a memory 925, code 930, and a processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some aspects, the transceiver 910 may include a wired transceiver and may communicate bi-directionally with another wired transceiver. Additionally, or alternatively, in some aspects, the transceiver 910 may include a wireless transceiver and may communicate bi-directionally with another wireless transceiver. In some aspects, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or memory components (for example, the processor 935, or the memory 925, or both), may be included in a chip or chip assembly that is installed in the device 905. In some aspects, the transceiver may be operable to support communications via one or more communications links (e.g., a communication link 125, a backhaul communication link 120, a midhaul communication link 162, a fronthaul communication link 168).

The memory 925 may include RAM and ROM. The memory 925 may store computer-readable, computer-executable code 930 including instructions that, when executed by the processor 935, cause the device 905 to perform various functions described herein. The code 930 may be stored in a non-transitory computer-readable medium such as system memory or another type of memory. In some cases, the code 930 may not be directly executable by the processor 935 but may cause a computer (e.g., when compiled and executed) to perform functions described herein. In some cases, the memory 925 may contain, among other things, a BIOS which may control basic hardware or software operation such as the interaction with peripheral components or devices.

The processor 935 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 935 may be configured to operate a memory array using a memory controller. In some other cases, a memory controller may be integrated into the processor 935. The processor 935 may be configured to execute computer-readable instructions stored in a memory (e.g., the memory 925) to cause the device 905 to perform various functions (e.g., functions or tasks supporting subscription-based techniques for communicating third-party information). For example, the device 905 or a component of the device 905 may include a processor 935 and memory 925 coupled with the processor 935, the processor 935 and memory 925 configured to perform various functions described herein. The processor 935 may be an example of a cloud-computing platform (e.g., one or more physical nodes and supporting software such as operating systems, virtual machines, or container instances) that may host the functions (e.g., by executing code 930) to perform the functions of the device 905. The processor 935 may be any one or more suitable processors capable of executing scripts or instructions of one or more software programs stored in the device 905 (such as within the memory 925). In some implementations, the processor 935 may be a component of a processing system. A processing system may generally refer to a system or series of machines or components that receives inputs and processes the inputs to produce a set of outputs (which may be passed to other systems or components of, for example, the device 905). For example, a processing system of the device 905 may refer to a system including the various other components or subcomponents of the device 905, such as the processor 935, or the transceiver 910, or the communications manager 920, or other components or combinations of components of the device 905. The processing system of the device 905 may interface with other components of the device 905, and may process information received from other components (such as inputs or signals) or output information to other components. For example, a chip or modem of the device 905 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 905 may transmit information output from the chip or modem. Additionally, or alternatively, in some implementations, the one or more interfaces may refer to an interface between the processing system of the chip or modem and a receiver, such that the device 905 may obtain information or signal inputs, and the information may be passed to the processing system. A person having ordinary skill in the art will readily recognize that a first interface also may obtain information or signal inputs, and a second interface also may output information or signal outputs.

In some aspects, a bus 940 may support communications of (e.g., within) a protocol layer of a protocol stack. In some aspects, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the memory 925, the code 930, and the processor 935 may be located in one of the different components or divided between different components).

In some aspects, the communications manager 920 may manage aspects of communications with a core network 130 (e.g., via one or more wired or wireless backhaul links). For example, the communications manager 920 may manage the transfer of data communications for client devices, such as one or more UEs 115. In some aspects, the communications manager 920 may manage communications with other network entities 105, and may include a controller or scheduler for controlling communications with UEs 115 in cooperation with other network entities 105. In some aspects, the communications manager 920 may support an X2 interface within an LTE/LTE-A wireless communications network technology to provide communication between network entities 105.

The communications manager 920 may support wireless communication at a first network entity of a first service provider in accordance with examples as disclosed herein. For example, the communications manager 920 may be configured as or otherwise support a means for obtaining, from a first UE associated with the first service provider, an invite message associated with initiation of a call between the first UE and a second UE associated with a second service provider, where the invite message, as obtained from the UE, includes an identity associated with the first UE and a third-party authorization server. The communications manager 920 may be configured as or otherwise support a means for determining, based on subscription information associated with the first UE, that the first UE is authorized to use the identity. The communications manager 920 may be configured as or otherwise support a means for obtaining, from the third-party authorization server based on the determination that the first UE is authorized to use the identity, third-party information associated with the first UE. The communications manager 920 may be configured as or otherwise support a means for outputting the invite message to a second network entity of the second service provider, where the invite message, as output to the second network entity, includes the third-party information.

Additionally, or alternatively, the communications manager 920 may support wireless communication at a first network entity of a first service provider in accordance with examples as disclosed herein. For example, the communications manager 920 may be configured as or otherwise support a means for obtaining, from a second network entity of a second service provider, an invite message associated with initiation of a call between a first UE associated with the first service provider and a second UE associated with the second service provider, where the invite message, as obtained from the second network entity, includes third-party information associated with the second UE. The communications manager 920 may be configured as or otherwise support a means for verifying the third-party information based on subscription information associated with the first UE that indicates that the first UE is subscribed to a service to verify the third-party information. The communications manager 920 may be configured as or otherwise support a means for outputting, to the first UE, the invite message, where the invite message, as output to the first UE, includes the third-party information based on the verification.

By including or configuring the communications manager 920 in accordance with examples as described herein, the device 905 may support techniques for service and security enhancements, for example, by supporting subscription-based third-party information communication and encryption. For example, such techniques may enable service providers to provide third-party information communication and encryption services as part of a call invitation between UEs 115 based on subscriptions of the UEs 115. As such, additional (e.g., third-party) information may be securely communicated as part of the call invitation, thereby improving user-experience while providing additional revenue opportunities to service providers, among other benefits.

In some aspects, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some aspects, one or more functions described with reference to the communications manager 920 may be supported by or performed by the transceiver 910, the processor 935, the memory 925, the code 930, or any combination thereof. For example, the code 930 may include instructions executable by the processor 935 to cause the device 905 to perform various aspects of subscription-based techniques for communicating third-party information as described herein, or the processor 935 and the memory 925 may be otherwise configured to perform or support such operations.

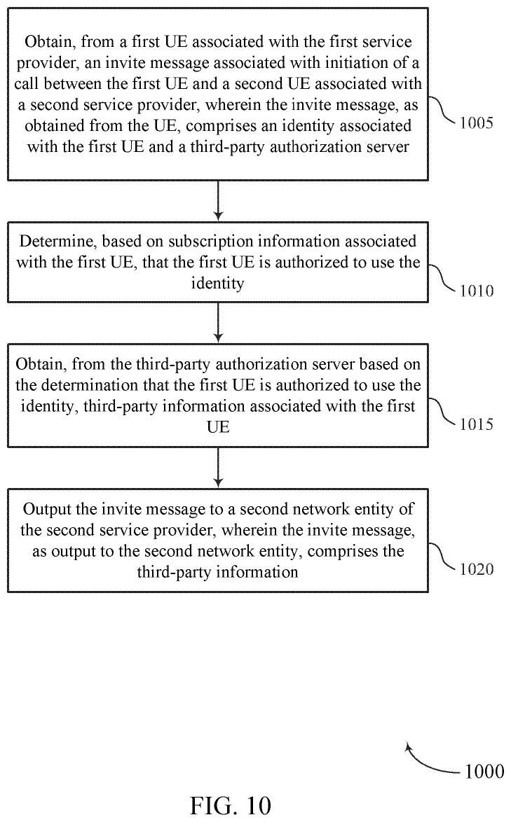

FIG. 10 shows a flowchart illustrating a method 1000 that supports subscription-based techniques for communicating third-party information in accordance with one or more aspects of the present disclosure. The operations of the method 1000 may be implemented by a network entity or its components as described herein. For example, the operations of the method 1000 may be performed by a network entity as described with reference to FIGS. 1 through 9. In some aspects, a network entity may execute a set of instructions to control the functional elements of the network entity to perform the described functions. Additionally, or alternatively, the network entity may perform aspects of the described functions using special-purpose hardware.

At 1005, the method may include obtaining, from a first UE associated with the first service provider, an invite message associated with initiation of a call between the first UE and a second UE associated with a second service provider, where the invite message, as obtained from the UE, includes an identity associated with the first UE and a third-party authorization server. The operations of 1005 may be performed in accordance with examples as disclosed herein. In some aspects, aspects of the operations of 1005 may be performed by a call component 825 as described with reference to FIG. 8.

At 1010, the method may include determining, based on subscription information associated with the first UE, that the first UE is authorized to use the identity. The operations of 1010 may be performed in accordance with examples as disclosed herein. In some aspects, aspects of the operations of 1010 may be performed by a subscription component 830 as described with reference to FIG. 8.

At 1015, the method may include obtaining, from the third-party authorization server based on the determination that the first UE is authorized to use the identity, third-party information associated with the first UE. The operations of 1015 may be performed in accordance with examples as disclosed herein. In some aspects, aspects of the operations of 1015 may be performed by a third-party component 835 as described with reference to FIG. 8.

At 1020, the method may include outputting the invite message to a second network entity of the second service provider, where the invite message, as output to the second network entity, includes the third-party information. The operations of 1020 may be performed in accordance with examples as disclosed herein. In some aspects, aspects of the operations of 1020 may be performed by a call component 825 as described with reference to FIG. 8.

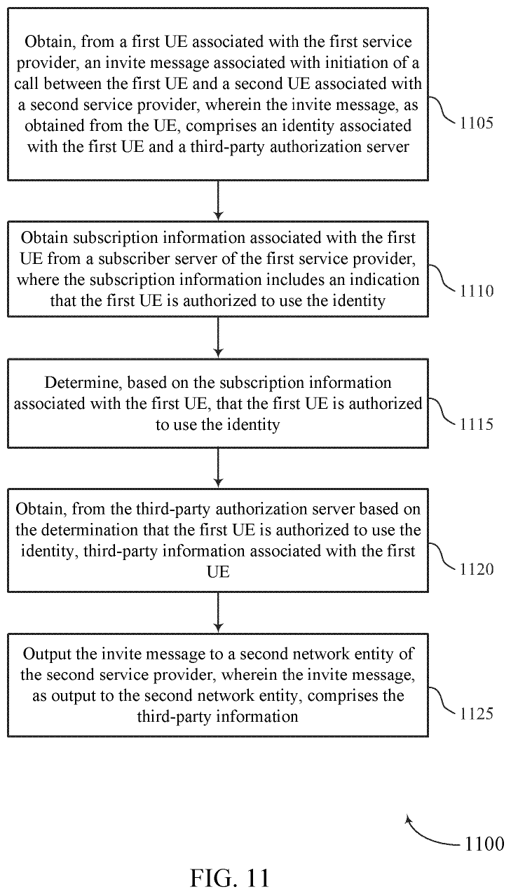

FIG. 11 shows a flowchart illustrating a method 1100 that supports subscription-based techniques for communicating third-party information in accordance with one or more aspects of the present disclosure. The operations of the method 1100 may be implemented by a network entity or its components as described herein. For example, the operations of the method 1100 may be performed by a network entity as described with reference to FIGS. 1 through 9. In some aspects, a network entity may execute a set of instructions to control the functional elements of the network entity to perform the described functions. Additionally, or alternatively, the network entity may perform aspects of the described functions using special-purpose hardware.

At 1105, the method may include obtaining, from a first UE associated with the first service provider, an invite message associated with initiation of a call between the first UE and a second UE associated with a second service provider, where the invite message, as obtained from the UE, includes an identity associated with the first UE and a third-party authorization server. The operations of 1105 may be performed in accordance with examples as disclosed herein. In some aspects, aspects of the operations of 1105 may be performed by a call component 825 as described with reference to FIG. 8.

At 1110, the method may include obtaining subscription information associated with the first UE from a subscriber server of the first service provider, where the subscription information includes an indication that the first UE is authorized to use the identity. The operations of 1110 may be performed in accordance with examples as disclosed herein. In some aspects, aspects of the operations of 1110 may be performed by a subscription component 830 as described with reference to FIG. 8.

At 1115, the method may include determining, based on the subscription information associated with the first UE, that the first UE is authorized to use the identity. The operations of 1115 may be performed in accordance with examples as disclosed herein. In some aspects, aspects of the operations of 1115 may be performed by a subscription component 830 as described with reference to FIG. 8.

At 1120, the method may include obtaining, from the third-party authorization server based on the determination that the first UE is authorized to use the identity, third-party information associated with the first UE. The operations of 1120 may be performed in accordance with examples as disclosed herein. In some aspects, aspects of the operations of 1120 may be performed by a third-party component 835 as described with reference to FIG. 8.

At 1125, the method may include outputting the invite message to a second network entity of the second service provider, where the invite message, as output to the second network entity, includes the third-party information. The operations of 1125 may be performed in accordance with examples as disclosed herein. In some aspects, aspects of the operations of 1125 may be performed by a call component 825 as described with reference to FIG. 8.

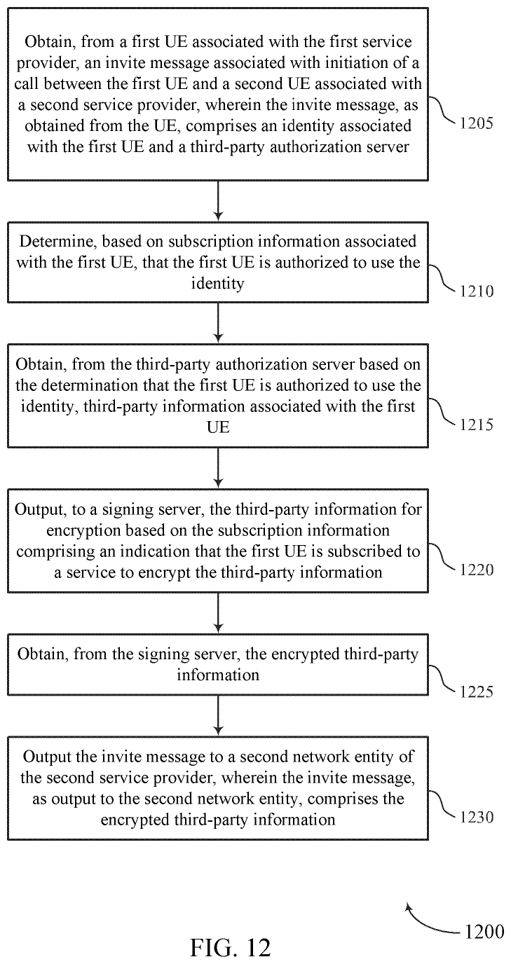

FIG. 12 shows a flowchart illustrating a method 1200 that supports subscription-based techniques for communicating third-party information in accordance with one or more aspects of the present disclosure. The operations of the method 1200 may be implemented by a network entity or its components as described herein. For example, the operations of the method 1200 may be performed by a network entity as described with reference to FIGS. 1 through 9. In some aspects, a network entity may execute a set of instructions to control the functional elements of the network entity to perform the described functions. Additionally, or alternatively, the network entity may perform aspects of the described functions using special-purpose hardware.

At 1205, the method may include obtaining, from a first UE associated with the first service provider, an invite message associated with initiation of a call between the first UE and a second UE associated with a second service provider, where the invite message, as obtained from the UE, includes an identity associated with the first UE and a third-party authorization server. The operations of 1205 may be performed in accordance with examples as disclosed herein. In some aspects, aspects of the operations of 1205 may be performed by a call component 825 as described with reference to FIG. 8.

At 1210, the method may include determining, based on subscription information associated with the first UE, that the first UE is authorized to use the identity. The operations of 1210 may be performed in accordance with examples as disclosed herein. In some aspects, aspects of the operations of 1210 may be performed by a subscription component 830 as described with reference to FIG. 8.

At 1215, the method may include obtaining, from the third-party authorization server based on the determination that the first UE is authorized to use the identity, third-party information associated with the first UE. The operations of 1215 may be performed in accordance with examples as disclosed herein. In some aspects, aspects of the operations of 1215 may be performed by a third-party component 835 as described with reference to FIG. 8.

At 1220, the method may include outputting, to a signing server, the third-party information for encryption based on the subscription information including an indication that the first UE is subscribed to a service to encrypt the third-party information. The operations of 1220 may be performed in accordance with examples as disclosed herein. In some aspects, aspects of the operations of 1220 may be performed by an encryption component 850 as described with reference to FIG. 8.

At 1225, the method may include obtaining, from the signing server, the encrypted third-party information. The operations of 1225 may be performed in accordance with examples as disclosed herein. In some aspects, aspects of the operations of 1225 may be performed by an encryption component 850 as described with reference to FIG. 8.

At 1230, the method may include outputting the invite message to a second network entity of the second service provider, where the invite message, as output to the second network entity, includes the encrypted third-party information. The operations of 1230 may be performed in accordance with examples as disclosed herein. In some aspects, aspects of the operations of 1230 may be performed by a call component 825 as described with reference to FIG. 8.

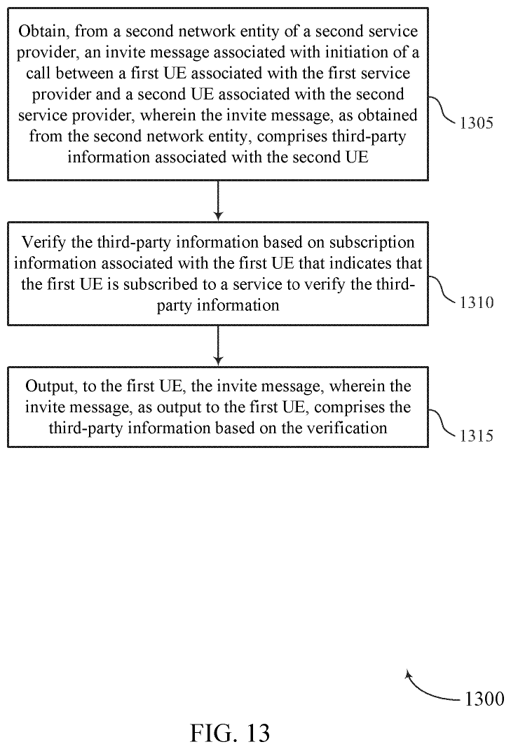

FIG. 13 shows a flowchart illustrating a method 1300 that supports subscription-based techniques for communicating third-party information in accordance with one or more aspects of the present disclosure. The operations of the method 1300 may be implemented by a network entity or its components as described herein. For example, the operations of the method 1300 may be performed by a network entity as described with reference to FIGS. 1 through 9. In some aspects, a network entity may execute a set of instructions to control the functional elements of the network entity to perform the described functions. Additionally, or alternatively, the network entity may perform aspects of the described functions using special-purpose hardware.

At 1305, the method may include obtaining, from a second network entity of a second service provider, an invite message associated with initiation of a call between a first UE associated with the first service provider and a second UE associated with the second service provider, where the invite message, as obtained from the second network entity, includes third-party information associated with the second UE. The operations of 1305 may be performed in accordance with examples as disclosed herein. In some aspects, aspects of the operations of 1305 may be performed by a call component 825 as described with reference to FIG. 8.

At 1310, the method may include verifying the third-party information based on subscription information associated with the first UE that indicates that the first UE is subscribed to a service to verify the third-party information. The operations of 1310 may be performed in accordance with examples as disclosed herein. In some aspects, aspects of the operations of 1310 may be performed by a verification component 840 as described with reference to FIG. 8.

At 1315, the method may include outputting, to the first UE, the invite message, where the invite message, as output to the first UE, includes the third-party information based on the verification. The operations of 1315 may be performed in accordance with examples as disclosed herein. In some aspects, aspects of the operations of 1315 may be performed by a call component 825 as described with reference to FIG. 8.

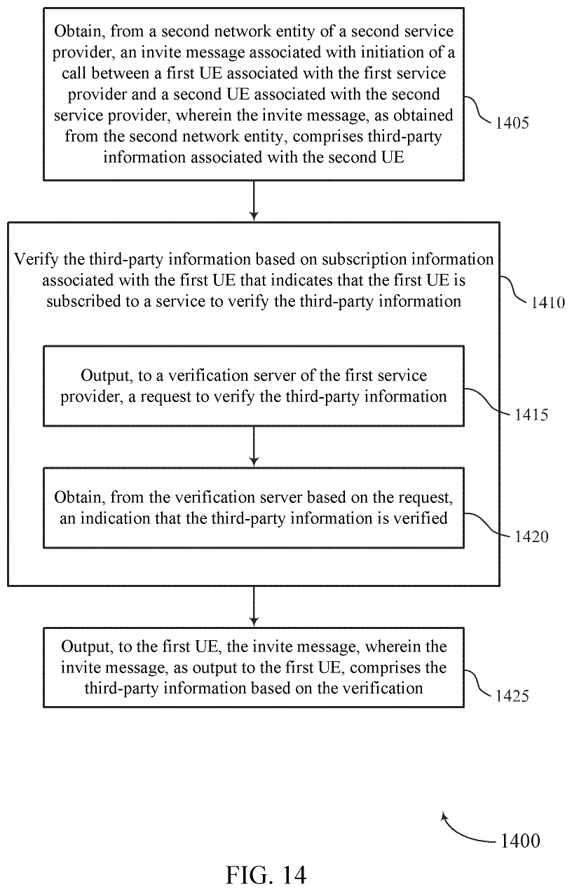

FIG. 14 shows a flowchart illustrating a method 1400 that supports subscription-based techniques for communicating third-party information in accordance with one or more aspects of the present disclosure. The operations of the method 1400 may be implemented by a network entity or its components as described herein. For example, the operations of the method 1400 may be performed by a network entity as described with reference to FIGS. 1 through 9. In some aspects, a network entity may execute a set of instructions to control the functional elements of the network entity to perform the described functions. Additionally, or alternatively, the network entity may perform aspects of the described functions using special-purpose hardware.

At 1405, the method may include obtaining, from a second network entity of a second service provider, an invite message associated with initiation of a call between a first UE associated with the first service provider and a second UE associated with the second service provider, where the invite message, as obtained from the second network entity, includes third-party information associated with the second UE. The operations of 1405 may be performed in accordance with examples as disclosed herein. In some aspects, aspects of the operations of 1405 may be performed by a call component 825 as described with reference to FIG. 8.

At 1410, the method may include verifying the third-party information based on subscription information associated with the first UE that indicates that the first UE is subscribed to a service to verify the third-party information. The operations of 1410 may be performed in accordance with examples as disclosed herein. In some aspects, aspects of the operations of 1410 may be performed by a verification component 840 as described with reference to FIG. 8.

In some cases, at 1415, to support (e.g., as part of) verifying the third-party information, the method may include outputting, to a verification server of the first service provider, a request to verify the third-party information. The operations of 1415 may be performed in accordance with examples as disclosed herein. In some aspects, aspects of the operations of 1415 may be performed by a verification component 840 as described with reference to FIG. 8.

In some cases, at 1420, to support (e.g., as part of) verifying the third-party information, the method may include obtaining, from the verification server based on the request, an indication that the third-party information is verified. The operations of 1420 may be performed in accordance with examples as disclosed herein. In some aspects, aspects of the operations of 1420 may be performed by a verification component 840 as described with reference to FIG. 8.

At 1425, the method may include outputting, to the first UE, the invite message, where the invite message, as output to the first UE, includes the third-party information based on the verification. The operations of 1425 may be performed in accordance with examples as disclosed herein. In some aspects, aspects of the operations of 1425 may be performed by a call component 825 as described with reference to FIG. 8.

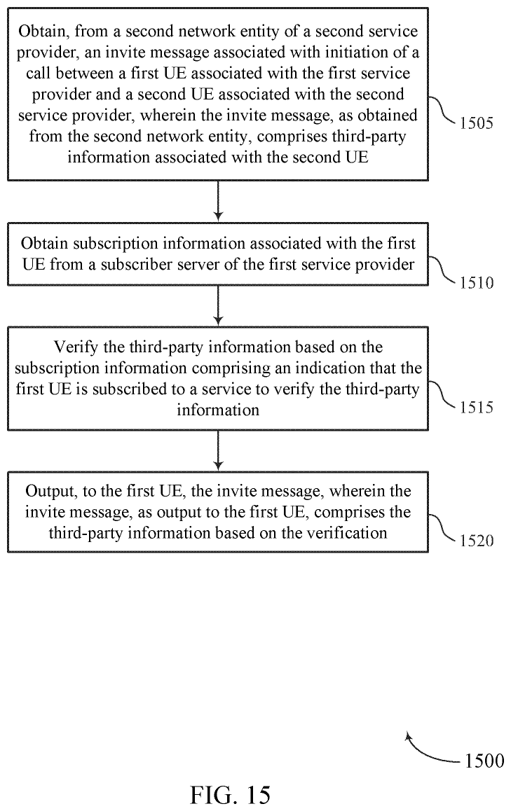

FIG. 15 shows a flowchart illustrating a method 1500 that supports subscription-based techniques for communicating third-party information in accordance with one or more aspects of the present disclosure. The operations of the method 1500 may be implemented by a network entity or its components as described herein. For example, the operations of the method 1500 may be performed by a network entity as described with reference to FIGS. 1 through 9. In some aspects, a network entity may execute a set of instructions to control the functional elements of the network entity to perform the described functions. Additionally, or alternatively, the network entity may perform aspects of the described functions using special-purpose hardware.

At 1505, the method may include obtaining, from a second network entity of a second service provider, an invite message associated with initiation of a call between a first UE associated with the first service provider and a second UE associated with the second service provider, where the invite message, as obtained from the second network entity, includes third-party information associated with the second UE. The operations of 1505 may be performed in accordance with examples as disclosed herein. In some aspects, aspects of the operations of 1505 may be performed by a call component 825 as described with reference to FIG. 8.

At 1510, the method may include obtaining subscription information associated with the first UE from a subscriber server of the first service provider. The operations of 1510 may be performed in accordance with examples as disclosed herein. In some aspects, aspects of the operations of 1510 may be performed by a subscription component 830 as described with reference to FIG. 8.

At 1515, the method may include verifying the third-party information based on the subscription information including an indication that the first UE is subscribed to a service to verify the third-party information. The operations of 1515 may be performed in accordance with examples as disclosed herein. In some aspects, aspects of the operations of 1515 may be performed by a verification component 840 as described with reference to FIG. 8.

At 1520, the method may include outputting, to the first UE, the invite message, where the invite message, as output to the first UE, includes the third-party information based on the verification. The operations of 1520 may be performed in accordance with examples as disclosed herein. In some aspects, aspects of the operations of 1520 may be performed by a call component 825 as described with reference to FIG. 8.

The following provides an overview of aspects of the present disclosure:

Aspect 1: A method for wireless communication at a first network entity of a first service provider, comprising: obtaining, from a first UE associated with the first service provider, an invite message associated with initiation of a call between the first UE and a second UE associated with a second service provider, wherein the invite message, as obtained from the UE, comprises an identity associated with the first UE and a third-party authorization server; determining, based on subscription information associated with the first UE, that the first UE is authorized to use the identity; obtaining, from the third-party authorization server based on the determination that the first UE is authorized to use the identity, third-party information associated with the first UE; and outputting the invite message to a second network entity of the second service provider, wherein the invite message, as output to the second network entity, comprises the third-party information.

Aspect 2: The method of aspect 1, wherein determining that the first UE is authorized to use the identity comprises: obtaining the subscription information from a subscriber server of the first service provider, wherein the subscription information comprises an indication that the first UE is authorized to use the identity.

Aspect 3: The method of any of aspects 1 through 2, further comprising: determining an address of the third-party authorization server based on the identity; and outputting, to the third-party authorization server based on the determination of the address, a request to verify whether the first UE is authorized to communicate the third-party information associated with the first UE via the invite message as output to the second network entity, wherein obtaining the third-party information comprises: obtaining the third-party information based on an authorization of the first UE to communicate the third-party information.

Aspect 4: The method of aspect 3, wherein outputting the request comprises outputting the request to the third-party authorization server via an exposure function of the first service provider for communicating with network entities outside of the first service provider, and obtaining the third-party information comprises obtaining the third-party information from the third-party authorization server via the exposure function.

Aspect 5: The method of any of aspects 1 through 4, further comprising: outputting, to a signing server, the third-party information for encryption based on the subscription information comprising an indication that the first UE is subscribed to a service to encrypt the third-party information; and obtaining, from the signing server, the encrypted third-party information, wherein the invite message, as output to the second network entity, comprises the encrypted third-party information.

Aspect 6: The method of any of aspects 1 through 4, further comprising: encrypting the third-party information based on the subscription information comprising an indication that the first UE is subscribed to a service to encrypt the third-party information, wherein the invite message, as output to the second network entity, comprises the encrypted third-party information.

Aspect 7: The method of any of aspects 1 through 6, further comprising: outputting, to the first UE during registration of the first UE with the first service provider, a message comprising information indicative of the identity based on the subscription information, wherein the invite message, as obtained from the first UE, comprises the identity based on the output of the message.

Aspect 8: The method of aspect 7, further comprising: obtaining, from the third-party authorization server, a request to allocate the identity to the first UE, wherein outputting the message comprising the information indicative of the identity comprises: outputting the message comprising the information indicative of the identity based on the request.

Aspect 9: The method of any of aspects 1 through 8, wherein obtaining the third-party information comprises: obtaining a name card that comprises the third-party information, wherein the invite message, as output the second network entity, comprises the name card.

Aspect 10: The method of any of aspects 1 through 9, wherein the identity is a public user identity.

Aspect 11: The method of aspect 10, wherein the public user identity is allocated by the third-party authorization server.

Aspect 12: The method of any of aspects 1 through 11, wherein the identity is a third-party specific user identity and the invite message, as obtained from the first UE, comprises a token associated with an authorization of the first UE to communicate the third-party information via the invite message as output to the second network entity.

Aspect 13: The method of any of aspects 1 through 12, wherein the third-party information is based on a display name included in the invite message as obtained from the first UE.

Aspect 14: The method of aspect 13, wherein the display name is included in a source header of the invite message as obtained from the first UE.

Aspect 15: The method of any of aspects 1 through 14, wherein the third-party information is based on one or more parameters included in a call-information header of the invite message as obtained from the first UE.

Aspect 16: The method of any of aspects 1 through 15, further comprising: obtaining, from a third UE associated with the first service provider, a second invite message associated with initiation of a second call between the third UE and a fourth UE associated with the second service provider, wherein the second invite message, as obtained from the third UE, comprises a second identity associated with the third UE and the third-party authorization server; determining, based on subscription information associated with the third UE, that the third UE is unauthorized to use the second identity; and outputting the second invite message to the second network entity, wherein the second invite message, as output to the second network entity, excludes third-party information associated with the third UE based on the third UE being unauthorized to use the second identity.

Aspect 17: A method for wireless communication at a first network entity of a first service provider, comprising: obtaining, from a second network entity of a second service provider, an invite message associated with initiation of a call between a first UE associated with the first service provider and a second UE associated with the second service provider, wherein the invite message, as obtained from the second network entity, comprises third-party information associated with the second UE; verifying the third-party information based on subscription information associated with the first UE that indicates that the first UE is subscribed to a service to verify the third-party information; and outputting, to the first UE, the invite message, wherein the invite message, as output to the first UE, comprises the third-party information based on the verification.

Aspect 18: The method of aspect 17, wherein verifying the third-party information comprises: outputting, to a verification server of the first service provider, a request to verify the third-party information; and obtaining, from the verification server based on the request, an indication that the third-party information is verified.

Aspect 19: The method of any of aspects 17 through 18, further comprising: obtaining the subscription information from a subscriber server of the first service provider, wherein the subscription information comprises an indication that the first UE is subscribed to the service.

Aspect 20: The method of any of aspects 17 through 19, further comprising: obtaining, from the second network entity, a second invite message associated with initiation of a second call between a third UE associated with the first service provider and a fourth UE associated with the second service provider, wherein the second invite message, as obtained from the second network entity, comprises third-party information associated with the fourth UE; determining that the third UE is unsubscribed from a service to verify the third-party information associated with the fourth UE based on second subscription information associated with the third UE; and outputting, to the third UE, the second invite message, wherein the second invite message, as output to the third UE, excludes the third-party information associated with the fourth UE based on the determination that the third UE is unsubscribed from the service to verify the third-party information associated with the fourth UE.

Aspect 21: A first network entity of a first service provider for wireless communication, comprising a memory and at least one processor coupled to the memory, wherein the at least one processor is configured to perform a method of any of aspects 1 through 16.

Aspect 22: A first network entity of a first service provider for wireless communication, comprising at least one means for performing a method of any of aspects 1 through 16.

Aspect 23: A non-transitory computer-readable medium having code for wireless communication stored thereon is described. The code, when executed by a first network entity of a first service provider, may cause the first network entity to perform a method of any of aspects 1 through 16.

Aspect 24: A first network entity of a first service provider for wireless communication, comprising a memory and at least one processor coupled to the memory, wherein the at least one processor is configured to perform a method of any of aspects 17 through 20.

Aspect 25: A first network entity of a first service provider for wireless communication, comprising at least one means for performing a method of any of aspects 17 through 20.

Aspect 26: A non-transitory computer-readable medium having code for wireless communication stored thereon is described. The code, when executed by a first network entity of a first service provider, may cause the first network entity to perform a method of any of aspects 17 through 20.

The methods described herein describe possible implementations, and the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration,” and not “preferred” or “advantageous over other aspects.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity of a first service provider for wireless communication, comprising:
a memory; and
at least one processor coupled to the memory, wherein the at least one processor is configured to:
obtain, from a first user equipment (UE) associated with the first service provider, an invite message associated with initiation of a call between the first UE and a second UE associated with a second service provider, wherein the invite message, as obtained from the UE, comprises an identity associated with the first UE and a third-party authorization server;
determine, based on subscription information associated with the first UE, that the first UE is authorized to use the identity;
obtain, from the third-party authorization server based on the determination that the first UE is authorized to use the identity, third-party information associated with the first UE; and
output the invite message to a second network entity of the second service provider, wherein the invite message, as output to the second network entity, comprises the third-party information.

2. The first network entity of claim 1, wherein, to determine that the first UE is authorized to use the identity, the at least one processor is configured to:
obtain the subscription information from a subscriber server of the first service provider, wherein the subscription information comprises an indication that the first UE is authorized to use the identity.

3. The first network entity of claim 1, wherein the at least one processor is further configured to:
determine an address of the third-party authorization server based on the identity; and
output, to the third-party authorization server based on the determination of the address, a request to verify whether the first UE is authorized to communicate the third-party information associated with the first UE via the invite message as output to the second network entity, wherein, to obtain the third-party information, the at least one processor is configured to:
obtain the third-party information based on an authorization of the first UE to communicate the third-party information.

4. The first network entity of claim 3, wherein:
to output the request, the at least one processor is configured to output the request to the third-party authorization server via an exposure function of the first service provider that is configured to communicate with network entities outside of the first service provider, and
to obtain the third-party information, the at least one processor is configured to obtain the third-party information from the third-party authorization server via the exposure function.

5. The first network entity of claim 1, wherein the at least one processor is further configured to:
output, to a signing server, the third-party information for encryption based on the subscription information comprising an indication that the first UE is subscribed to a service to encrypt the third-party information; and
obtain, from the signing server, the encrypted third-party information, wherein the invite message, as output to the second network entity, comprises the encrypted third-party information.

6. The first network entity of claim 1, wherein the at least one processor is further configured to:
encrypt the third-party information based on the subscription information comprising an indication that the first UE is subscribed to a service to encrypt the third-party information, wherein the invite message, as output to the second network entity, comprises the encrypted third-party information.

7. The first network entity of claim 1, wherein the at least one processor is further configured to:
output, to the first UE during registration of the first UE with the first service provider, a message comprising information indicative of the identity based on the subscription information, wherein the invite message, as obtained from the first UE, comprises the identity based on the output of the message.

8. The first network entity of claim 7, wherein the at least one processor is further configured to:
obtain, from the third-party authorization server, a request to allocate the identity to the first UE, wherein, to output the message comprising the information indicative of the identity, the at least one processor is configured to:
output the message comprising the information indicative of the identity based on the request.

9. The first network entity of claim 1, wherein, to obtain the third-party information, the at least one processor is configured to:
obtain a name card that comprises the third-party information, wherein the invite message, as output the second network entity, comprises the name card.

10. The first network entity of claim 1, wherein the identity is a public user identity.

11. The first network entity of claim 10, wherein the public user identity is allocated by the third-party authorization server.

12. The first network entity of claim 1, wherein the identity is a third-party specific user identity and the invite message, as obtained from the first UE, comprises a token associated with an authorization of the first UE to communicate the third-party information via the invite message as output to the second network entity.

13. The first network entity of claim 1, wherein the third-party information is based on a display name included in the invite message as obtained from the first UE.

14. The first network entity of claim 13, wherein the display name is included in a source header of the invite message as obtained from the first UE.

15. The first network entity of claim 1, wherein the third-party information is based on one or more parameters included in a call-information header of the invite message as obtained from the first UE.

16. The first network entity of claim 1, wherein the at least one processor is further configured to:
obtain, from a third UE associated with the first service provider, a second invite message associated with initiation of a second call between the third UE and a fourth UE associated with the second service provider, wherein the second invite message, as obtained from the third UE, comprises a second identity associated with the third UE and the third-party authorization server;
determine, based on subscription information associated with the third UE, that the third UE is unauthorized to use the second identity; and
output the second invite message to the second network entity, wherein the second invite message, as output to the second network entity, excludes third-party information associated with the third UE based on the third UE being unauthorized to use the second identity.

17. A first network entity of a first service provider for wireless communication, comprising:
a memory; and
at least one processor coupled to the memory, wherein the at least one processor is configured to:
obtain, from a second network entity of a second service provider, an invite message associated with initiation of a call between a first user equipment (UE) associated with the first service provider and a second UE associated with the second service provider, wherein the invite message, as obtained from the second network entity, comprises third-party information associated with the second UE;
verify the third-party information based on subscription information associated with the first UE that indicates that the first UE is subscribed to a service to verify the third-party information; and
output, to the first UE, the invite message, wherein the invite message, as output to the first UE, comprises the third-party information based on the verification.

18. The first network entity of claim 17, wherein, to verify the third-party information, the at least one processor is configured to:
output, to a verification server of the first service provider, a request to verify the third-party information; and
obtain, from the verification server based on the request, an indication that the third-party information is verified.

19. The first network entity of claim 17, wherein the at least one processor is further configured to:
obtain the subscription information from a subscriber server of the first service provider, wherein the subscription information comprises an indication that the first UE is subscribed to the service.

20. The first network entity of claim 17, wherein the at least one processor is further configured to:
obtain, from the second network entity, a second invite message associated with initiation of a second call between a third UE associated with the first service provider and a fourth UE associated with the second service provider, wherein the second invite message, as obtained from the second network entity, comprises third-party information associated with the fourth UE;
determine that the third UE is unsubscribed from a service to verify the third-party information associated with the fourth UE based on second subscription information associated with the third UE; and
output, to the third UE, the second invite message, wherein the second invite message, as output to the third UE, excludes the third-party information associated with the fourth UE based on the determination that the third UE is unsubscribed from the service to verify the third-party information associated with the fourth UE.

21. A method for wireless communication at a first network entity of a first service provider, comprising:
obtaining, from a first user equipment (UE) associated with the first service provider, an invite message associated with initiation of a call between the first UE and a second UE associated with a second service provider, wherein the invite message, as obtained from the UE, comprises an identity associated with the first UE and a third-party authorization server;
determining, based on subscription information associated with the first UE, that the first UE is authorized to use the identity;
obtaining, from the third-party authorization server based on the determination that the first UE is authorized to use the identity, third-party information associated with the first UE; and
outputting the invite message to a second network entity of the second service provider, wherein the invite message, as output to the second network entity, comprises the third-party information.

22. The method of claim 21, wherein determining that the first UE is authorized to use the identity comprises:
obtaining the subscription information from a subscriber server of the first service provider, wherein the subscription information comprises an indication that the first UE is authorized to use the identity.

23. The method of claim 21, further comprising:
determining an address of the third-party authorization server based on the identity; and
outputting, to the third-party authorization server based on the determination of the address, a request to verify whether the first UE is authorized to communicate the third-party information associated with the first UE via the invite message as output to the second network entity, wherein obtaining the third-party information comprises:
obtaining the third-party information based on an authorization of the first UE to communicate the third-party information.

24. The method of claim 21, further comprising:
outputting, to a signing server, the third-party information for encryption based on the subscription information comprising an indication that the first UE is subscribed to a service to encrypt the third-party information; and
obtaining, from the signing server, the encrypted third-party information, wherein the invite message, as output to the second network entity, comprises the encrypted third-party information.

25. The method of claim 21, further comprising:
outputting, to the first UE during registration of the first UE with the first service provider, a message comprising information indicative of the identity based on the subscription information, wherein the invite message, as obtained from the first UE, comprises the identity based on the output of the message.

26. The method of claim 21, wherein obtaining the third-party information comprises:
obtaining a name card that comprises the third-party information, wherein the invite message, as output the second network entity, comprises the name card.

27. The method of claim 21, wherein the third-party information is based on a display name included in the invite message as obtained from the first UE.

28. The method of claim 21, wherein the third-party information is based on one or more parameters included in a call-information header of the invite message as obtained from the first UE.

29. A method for wireless communication at a first network entity of a first service provider, comprising:
obtaining, from a second network entity of a second service provider, an invite message associated with initiation of a call between a first user equipment (UE) associated with the first service provider and a second UE associated with the second service provider, wherein the invite message, as obtained from the second network entity, comprises third-party information associated with the second UE;
verifying the third-party information based on subscription information associated with the first UE that indicates that the first UE is subscribed to a service to verify the third-party information; and
outputting, to the first UE, the invite message, wherein the invite message, as output to the first UE, comprises the third-party information based on the verification.

30. The method of claim 29, wherein verifying the third-party information comprises:
outputting, to a verification server of the first service provider, a request to verify the third-party information; and
obtaining, from the verification server based on the request, an indication that the third-party information is verified.
